(19) United States
(12) Patent Application Publication
(10) Pub. No.: US 2017/0362551 A1
(43) Pub. Date: Dec. 21, 2017

(54) LAUNDRY AID AND USE THEREOF

(71) Applicant: Ahlstrom-Munksjö Oyj, Helsinki (FI)

(72) Inventors: Samuel MERLET, Vaulnaveys-le-haut (FR); Rui FERREIRA, Longmont, CO (US); Diego FANTINI, Pont-Eveque (FR)

(73) Assignee: Ahlstrom-Munksjö Oyj, Helsinki (FI)

(21) Appl. No.: 15/535,770

(22) PCT Filed: Dec. 14, 2015
(86) PCT No.: PCT/EP2015/079578

§ 371 Date: Jun. 14, 2017

(30) Foreign Application Priority Data
Dec. 15, 2014 (EP) 14198048.2

(51) Int. Cl. C11D 17/04; C11D 3/00; C11D 3/37

(52) U.S. Cl. CPC C11D 17/049; C11D 3/3753; C11D 3/0021; C11D 3/3723

(57) ABSTRACT

A dye-capturing laundry aid comprising: a support in the form of a sheet comprising water-insoluble fibers; a first substance anchored to the support, wherein the first substance has moieties that are cationic when exposed to water at one or more pH values in the pH range of from 6 to 10; and a second substance that coats the first substance, wherein the second substance is a polymer that remains substantially coated upon the first substance when the laundry aid is exposed to water over the pH range of from 6 to 10, and at least 50% of the repeating units in the polymer have a structure according to the following Formula (1).

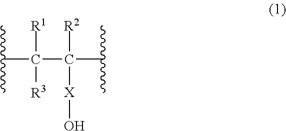

### TECHNICAL FIELD

The present invention relates to a laundry aid that is capable of capturing dyes from aqueous media. The present invention also encompasses using the laundry aid to capture dyes from wash liquor during the laundering of items from which dyes may leach, such as textiles, and efficient processes for producing the laundry aid.

### BACKGROUND ART

Manufacturers of everyday items often color their products in order to improve consumer appeal. For instance, manufacturers of fabrics, such as tablecloths, bedding and clothing, typically add dyes to their fabrics so that the end product is more aesthetically pleasing to the consumer. However, consumer appeal diminishes over the lifetime of the product if the initially pleasing color deteriorates. This is a particular problem with household fabric products because frequently laundering colored fabrics in order to remove dirt can also remove dye compounds by causing them to leach into the wash liquor.

The leaching of dyes into the wash liquor creates further problems because dyes leaching from one fabric can discolor other fabrics present in the same wash liquor. For example, simultaneously laundering a red fabric and a white fabric can lead to the white fabric being discolored due to it absorbing dye that has leached from the red fabric. One approach to this problem is to periodically bleach discolored white fabrics, but the use of bleach is a harsh process that can limit the lifetime of the fabric by degrading its fibers. Moreover, bleaching itself discolors non-white fabrics, and so bleaching cannot be used with fabrics that include both white and colored portions. An alternative approach is to only wash like-colored fabrics together, but this is an inconvenient and time-consuming solution to the problems caused by dyes leaching into wash liquor.

The laundry industry has attempted to address this issue by devising laundry aids that are designed to capture dyes molecules that have leached out of fabrics and into the wash liquor before they dye other fabrics. Typically, these laundry aids are provided in the form of a woven or non-woven cloth or fabric that is insoluble in the wash liquor, and which is equipped with a chemical treatment that can capture the fugitive dyes. The mechanism by which the dye-capture chemical operates is not particularly limited. It can, for instance, be capable of forming covalent bonds with dye compounds diffusing through the wash liquor. Alternatively, the chemical treatment can capture dyes by forming strong intermolecular interactions with dye compounds, such as by ionic interactions or by π-π interactions between aromatic rings.

For example, EP-A-1 889 900 reports a detergent article comprising a flexible carrier, such as a nonwoven fabric, and a dye-scavenger component in the form of an imidazole-epichlorohydrin copolymer. The imidazole-epichlorohydrin copolymer is selected as the dye-scavenger because it is believed that this particular polymer is also able to adsorb strongly to the flexible carrier and is therefore less likely to disassociate from the detergent article during a laundering operation. Accordingly, the detergent article of EP-A-1 889 900 lacks versatility because it requires a very particular dye-scavenging copolymer. It is also not clear whether the strong physical adsorption attributed to the imidazole-epichlorohydrin copolymer is independent of the flexible carrier, which further points to a lack of versatility.

Despite these advances, there is a need for a laundry aid that is better able to capture dyes from aqueous compositions, such as the wash liquor of a domestic laundering process. The technology underlying the laundry aid would ideally be versatile in terms of the various components that can be used to make the laundry aid, and it would also be highly beneficial if such a laundry aid could be produced using a cost-effective, rapid and efficient process that avoids hazardous chemicals. These and others needs are addressed by the present invention.

### SUMMARY OF THE INVENTION

The present invention provides an improved dye-capturing laundry aid comprising:
a support in the form of a sheet comprising water-insoluble fibers;
a first substance anchored to the support, wherein the first substance has moieties that are cationic when exposed to water at one or more pH values in the pH range of from 6 to 10; and
a second substance that coats the first substance, wherein the second substance is a polymer (sometimes referred to as the ‘second polymer’ hereafter) that remains substantially coated upon the first substance when the laundry aid is exposed to water over the pH range of from 6 to 10, and at least 50% of the repeating units in the polymer have a structure according to the following Formula (1):

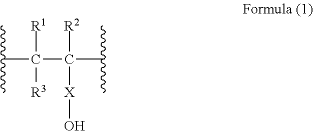

wherein R¹, R² and R³ each independently represents H or a C₁₋₃ alkyl group, a C₂₋₃ alkenyl group, a C₃₋₆ cycloalkyl group, a C₆₋₁₀ aryl group or a C₃₋₆ heterocyclic group, and each of which being optionally substituted with a hydroxyl group; and
X represents a covalent bond, a C₁₋₃ alkylene group, a C₃₋₆ cycloalkylene group, a C₆₋₁₀ arylene group or a C₃₋₆ heterocyclic group.

Without wishing to be bound by theory, it is believed that the cationic moieties of the first substance are responsible for capturing anionic dye molecules by virtue of electrostatic interactions. Coating another substance, i.e. the second substance, on the first substance is therefore prima facie contrary to the notion of capturing dye molecules with the first substance. However, the present inventors observed that the ability of laundry aids to capture dye molecules from the wash liquor is impaired by competitive binding with other chemicals in the laundry liquor. This problem occurs because other substances present in the laundry liquor can be attracted to the laundry aid by the same types of chemical interactions as those that are responsible for the intended dye capture. For instance, designing a laundry aid to capture dye molecules due to their anionic charge will suffer competitive binding from other anionic substances in the wash liquor, such as anionic surfactants. The present inventors realised that this can significantly impair the performance of a laundry aid.

As will be described below, and without wishing to be bound by theory, it is believed that the second substance counterintuitively improves the ability of the laundry aid to capture dye molecules by dramatically reducing the extent to which other species present in the wash liquor competitively bind to the laundry aid. The second substance therefore unexpectedly improves the ability of the first substance to capture dye molecules from the wash liquor, despite nominally forming an obstacle to this mechanism because it is coated upon the first polymer.

Since the first substance is securely held within the laundry aid by virtue of being anchored to the support fibers, the captured dye compounds are held firmly in place by being indirectly bound to the support fibers. Accordingly, dye compounds captured during a laundering process are held firmly in place by the laundry aid, rather than allowing the dye compounds to dissociate from the laundry aid and cause unwanted color runs, i.e. the unwanted migration of dye molecules from one garment to another during the laundering process.

A further unexpected advantage of this laundry aid is that the first and second substances confer surprisingly good structural integrity to the laundry aid, meaning that the laundry aid can easily withstand the tumbling motion of a laundering process without breaking up. This is a significant advantage over traditional laundry aids, which normally require the addition of a binder material in order to confer such structural integrity.

For example, some laundry aids of the type discussed above are those in which the first substance is a first polymer that is a water-soluble polyamine comprising primary amine groups and is anchored to the support as part of a three-dimensional network entangled with at least some of the fibers contained in the support. This three-dimensional network comprises the first polymer cross-linked by a third polymer, the third polymer being a water soluble polymer that is different from the first polymer and comprises repeating units comprising halohydrin and/or epoxide groups that are capable of forming covalent cross-links with the primary amine groups of the first polymer.

As will be discussed below, this material is highly effective at capturing and then firmly retaining dye compounds by virtue of the strong affinity between dye compounds and the first and, optionally, third polymers in the three-dimensional network entangled with the support fibers. As there is no need for the three-dimensional network to be chemically bonded to the support fibers, a greater variety of support fibers can be used in conjunction with the present invention. Traditional laundry aids have required direct chemical bonding between the support and the dye-capturing molecules, but this precludes chemically inert support fibers, such as polyalkenes. The present invention can tolerate such chemically inert fibers, meaning that the user benefits from increased versatility in this respect.

A further advantage of the present invention is that the laundry aid can be readily produced in an efficient, versatile, cost-effective and environmentally friendly manner.

### FIGURES

FIG. 1: Schematic illustration of a three-dimensional network entangling with a support fiber, wherein: the first polymer 1 and the third polymer 2 are mixed in FIG. 1A; the mixed first and third polymers are impregnated around the support fiber 3 in FIG. 1B; and the third polymer cross-links the first polymer in FIG. 1C.

FIG. 2: A graph depicting the effect of various surfactants on the ability of laundry aids to capture dye molecules.

FIG. 3: A graph illustrating the performance of various laundry aids.

### DESCRIPTION

Definitions

Average molecular weight: unless stated otherwise, ‘average molecular weight’ denotes number average molecular weight.

Average: unless stated otherwise, the term ‘average’ denotes mean average.

Weight/Mass: references to amounts ‘by weight’ are intended to be synonymous with ‘by mass’; these terms are used interchangeably.

Polymer: a compound comprising upwards of ten repeating units such as, for example, a homopolymer, a copolymer, a graft copolymer, a branch copolymer or a block copolymer.

Components of the Laundry Aid

As mentioned above, the laundry-capturing aid of the present invention comprises a support containing fibers, a first substance and a second substance. These and other features of the present invention are discussed in detail in the following sections.

Fiber-Containing Support

The laundry aid comprises a fiber-containing support to which the first substance is anchored. The type, nature and size of the support are not particularly limited, which is advantageous in terms of versatility. An important aspect of the present invention is that the support fibers do not need to chemically bond to the first substance. The first substance can instead be anchored to the support in a variety of ways, as will be discussed below. This is beneficial since a wide variety of support fibers can be used, including chemically inert fibers such as polypropylene.

Generally speaking, the support provides a scaffold for the laundry aid. This tends to make the laundry aid easier to handle, which further lends to the convenient use of the laundry aid. The support can also be helpful during the production process because it provides structural integrity by acting as a scaffold prior to completion of the laundry aid.

The types of fibers found in the support are not particularly limited, and can be natural or synthetic. For the avoidance of doubt, the term ‘fiber’ denotes short cut or staple fibers, as well as filaments. The fiber is typically water insoluble, which enables it to act as an insoluble scaffold and thereby prevent the laundry aid from disintegrating during use in an aqueous medium. Examples of suitable fiber types include cellulose, viscose, lyocell, cotton, polyamide, polyalkenes such as polyethylene, polypropylene and polybutylene, polyesters such as polylactic acid and poly(alkylene terephthalate) and copolymers thereof. It is also envisaged that glass fibers/filaments can be used since the three-dimensional network does not need to covalently bond to the support fibers.

Particularly suitable fibers include cellulose, viscose, lyocell, polyalkenes such as polyethylene and polybutylene, polyesters, a poly(alkylene terephthalate) and copolymers thereof. Sometimes it can useful to use a fully synthetic substrate, in which case the fibers in the support can consist of polyalkene or polyester fibers or a mixture or copolymer thereof. The laundry aid can also accommodate a mixture of fibers, such as a mixture of cellulose and viscose.

There is no particular limitation on the diameters and lengths of the fibers incorporated in the support. Instead, the diameters and lengths can be determined by the user based upon their knowledge of their art and depending upon the intended end use.

There is no particular limitation regarding the type of fibrous substrate that can be used for the invention, but suitable substrates can be a woven, knitted or nonwoven material. Preferred substrates are synthetic polyolefin spunbond or meltblown nonwovens or combination of thereof.

Spunbond refers to a material formed by extruding molten thermoplastic material as filaments from a plurality of fine capillary spinnerets with the diameter of the extruded filaments then being rapidly reduced as described in, for example, in U.S. Pat. No. 4,340,563 U.S. Pat. No. 3,692,618, U.S. Pat. No. 3,802,817, U.S. Pat. No. 3,338,992, U.S. Pat. No. 3,341,394, U.S. Pat. No. 3,502,763 and U.S. Pat. No. 3,542,615. The shape of the spinnerets is not particularly limited, though it is usually circular. Spunbond fibers are generally not tacky when they are deposited onto a collecting surface. Spunbond fibers are generally continuous and have average diameters larger than 7 microns, more particularly, between about 10 and 20 microns.

Meltblown refers to a material formed by extruding a molten thermoplastic material through a plurality of fine die capillaries as molten threads or filaments into converging high velocity, usually hot, gas (e.g. air) streams which attenuate the filaments of molten thermoplastic material to reduce their diameter. The shape of the dye capillaries is not particularly limited, though they are usually circular. Thereafter, the meltblown fibers are carried by the high velocity gas stream and are deposited on a collecting surface to form a web of randomly dispersed meltblown fibers. Such a process is disclosed in, for example, U.S. Pat. No. 3,849,241. Meltblown fibers are microfibers which may be continuous or discontinuous, are generally smaller than 10 microns in average diameter, and are generally tacky when deposited onto a collecting surface.

A combination of spunbond and meltblown materials can be a laminate in which some of the layers are spunbond and some are meltblown such as a spunbond/meltblown/spunbond (SMS) laminate and others, as disclosed in U.S. Pat. No. 4,041,203, U.S. Pat. No. 5,169,706, U.S. Pat. No. 5,145,727, U.S. Pat. No. 5,178,931 and U.S. Pat. No. 5,188,885.

Spunbond or meltblown can be made from polypropylene, polyester, polyethylene, polyimide, or combinations thereof.

Spunbond can also be made of multi-component fibers. The multi-component fibers may be formed by methods, such as those described in U.S. Pat. No. 6,074,590. Generally, multi-component fibers are formed by co-extrusion of at least two different components into one fiber or filament, The resulting fiber includes at least two different essentially continuous polymer phases. In one non-limiting embodiment, the multi-component fibers include bicomponent fibers. Such multi-component spunbond fibers are particularly useful as heat sealable material.

Another preferred nonwoven substrate is a drylaid carded nonwoven consolidated either chemically, thermally or by mechanical entanglements. Examples of nonwoven materials consolidated with mechanical entanglements are needlepunched or spunlaced nonwovens that are created by mechanically orienting and interlocking the fibers of a carded web. Useful ways to obtain such nonwovens are disclosed in U.S. Pat. No. 5,928,973, U.S. Pat. No. 5,895,623, U.S. Pat. No. 5,009,747, U.S. Pat. No. 4,154,889, U.S. Pat. No. 3,473,205. The staple fibers are generally short fibers, such as in cotton, having a length of about 35 to 80 mm, or they can be short cut synthetic fibers having a length of about 35 to 80 mm, and size from about 1 to 30 decitex.

Another preferred nonwoven substrate is a wetlaid nonwoven. Wetlaid nonwovens are produced in a process similar to paper making. The nonwoven web is produced by filtering an aqueous suspension of fiber onto a screen conveyor belt or perforated drum. Additional water is then squeezed out of the web and the remaining water is removed by drying. Bonding may be completed during drying or a bonding agent, e.g. an adhesive, may be subsequently added to the dried web and then the web is cured. Techniques for wetlaying fibrous material are well known in the art as described in EP-A-0 889 151. Fibers used in wetlaying processes typically have a length from about 5 to 38 mm and a size from 0.5 to 17 decitex.

The fiber-containing support can be formed exclusively of fibers or other components can be added as required. For example, wet strength additives can be added in order to improve the structural integrity of the fiber-containing support.

The support is provided in the form of a sheet. For example, typical laundry aids are provided in the form of a cloth-like sheet that tumbles and deforms easily without breaking during the churning motion of a domestic washing machine. In particular, the fiber-containing support can be provided as a woven or non-woven sheet/web prior to the addition of the first and second substances. The size of such a sheet is not particularly limited, and can depend upon the intended use, but a sheet having a length of 5-30 cm, a width of 5-30 cm and a thickness of <0.5 cm can often be satisfactory. The sheet can, moreover, be subsequently manipulated into the form of a block, sphere, cylinder, tube, torus, a porous sachet and so forth.

First Substance

The first substance is anchored to the support, which prevents it from separating from the support during use. The way in which the first substance is anchored to the support is not particularly limited, provided that satisfactory anchoring is achieved. This versatility is a significant advantage associated with the present invention, as it allows the user to employ a greater variety of supports and first substances. Laundry aids not having this versatility would be limited to a smaller range of supports and first substances to ensure satisfactory anchoring.

The first substance can, for example, be anchored to the support by chemical bonds between the first substance and the support fibers. Suitable chemical bonds include covalent bonds, ionic bonds, hydrogen bonds and dative covalent bonds, and more than one type of chemical bonding can be employed. In instances where the first substance is chemically bonded to the fibers of the support, the first substance can be bonded directly to the support fibers or via an intermediate chemical linkage, such as a cross-linking compound that bonds to both the support fibers and the first substance.

The first substance can also be anchored to the support without the need for chemical bonding to the support, either directly or via an intermediate chemical linkage. For example, the molecules or polymer chains of the first substance can be anchored by being entangled with the fibers of the support as part of a three-dimensional network. This approach to anchoring the first substance to the support can be supplemented by takings steps to restrict the freedom of movement of the first substance within the three-dimensional network. This can be achieved by forming chemical bonds between separate polymer chains/molecules of the first substance and/or between different parts of the same polymer chain/molecule (which has the effect of lassoing the molecules/polymer chains of the first substance around the support fibers). Such chemical bonds can be formed directly between separate molecules/polymer chains of the first substance and/or between different parts of the same molecule/polymer chain or via an intermediate chemical linkage. The latter embodiment is explained in greater detail below by reference to a three-dimensional network comprising the first polymer as the first substance and a third polymer that cross-links the first polymer, which forms a matrix around the support fibers.

The first substance has cationic moieties, which is to say that these moieties have positive charge in an aqueous medium, i.e. water, at one or more pH values in the range of from 6 to 10, i.e. the typical pH values encountered during the laundering of textiles, fabrics and so forth. This means that the cationic moieties can be cationic over the entirety of this pH range, for example, or can be cationic over only a portion of this pH range. Moreover, the first substance can include more than one type of cationic moiety. For example, some of these moieties can be cationic throughout the pH range of from 6 to 10 and some of these moieties can be cationic at only some of the pH values in the range of from 6 to 10. In some embodiments, at least some of the cationic moieties are moieties having a positive charge when exposed to water at pH 10.

The cationic character can stem from moieties that have a positive charge irrespective of pH, such as a quaternary ammonium group, or it can stem from moieties that do not have a permanent positive charge, but that do have a positive charge under the above conditions. For example, if the first substance comprises primary amine groups, then these groups can serve as cationic moieties because primary amines tend to be protonated at a pH of 6-10. Positively charged groups are helpful for a number of reasons. In particular, the positively charged regions of the first substance help to electrostatically capture the types of anionic dyes (sometimes called acid dyes in this technical field) that are typically used to colour cloth items.

The first substance can be polymeric or non-polymeric. Where the first substance is non-polymeric, it can comprise one or a plurality of cationic moieties per molecule. The types of groups that can serve as the cationic moieties of non-polymeric embodiments of the first substance are generally the same as those for polymeric embodiments of the first substance, and include groups such as amine and ammonium groups as highlighted below in respect of the first polymer.

The manner in which non-polymeric embodiments of the first substance are anchored to the support is not particularly limited. However, as non-polymeric molecules tend to be shorter than polymer chains, it is preferable to anchor non-polymeric molecules of the first substance using chemically bonds since it is generally more challenging to entangle shorter molecules with the support fibers.

The non-polymeric molecules are preferably covalently bonded to fibers of the support, as covalent bonds tend to be more robust than other types of bonds, such as hydrogen bonds, and therefore tend to be better able to withstand the rigors of a laundering process. The type of covalent bond is not particularly limited, and can include C—C, C—O, O—C, C—N, N—C, S—C, C—S bonds and so forth. Covalent bonds forming the link between the first substance and the support fibers can therefore form part of a chemical group such as an ester, amide, ether, carbonate, carbamate, imide, alkene and/or sulfide for example. One approach to forming covalent bonds is to react a nucleophilic group with an electrophilic group.

For example, modifying fibers of the support to include acid chloride functional groups enables covalent bonds to form with molecules of the first substance comprising nucleophilic functional groups such as alcohols and amines, which would result in an ester or amide functional group. An ether or amine could be formed by reacting an alcohol or primary/secondary amine with an epoxide or aziridine. Alternatively, covalent bonds can be formed as part of a pericyclic reaction such as a Diels-Alder reaction between an alkene and a diene, which would lead to the alkene group mentioned above.

The above discussion of chemical bonding between the first substance and support fibers is phrased in terms of direct chemical bonding between molecules of the first substance and the support fibers, but the skilled person will appreciate that the underlying concepts also apply to embodiments in which the first substance is chemically bonded to the support fibers via an intermediary chemical compound. For example, the bonding modes used to form bonds between molecules of the first substance and the support fibers can also be used to bond an intermediary molecule to both support fibers and molecules of the first substance.

The first substance can be a first polymer, wherein the cationic moieties can be located in the main polymer backbone and/or in side-chains of the first polymer. The first polymer can, for instance, be a polyamine, which is to say that it is a polymer comprising repeating units that have amine groups. The person skilled in this technical field would therefore appreciate that a polymeric polyamine will contain a large number of amine groups, preferably containing upwards of 50 amine groups. For example, the first polymer can be a polymer in which all repeating units possess an amine group, such as a homopolymer of one amine-containing repeating unit, or a copolymer of plural repeating units each possessing an amine group. Alternatively, the first polymer can be a copolymer possessing amine groups in only some of its repeating units. Copolymers representing the first polymer can be a random copolymer, block copolymer or graft copolymer, for example.

The amine groups that can be present in the first polymer can be primary amines, secondary amines, tertiary amines and/or quaternary ammonium groups, provided that at least some primary amine groups are present in the first polymer in isolation. Moreover, different repeating units of the first polymer can have different types of amines.

Without wishing to be bound by theory, it is believed that when amine groups are present, they serve multiple purposes. On the one hand, the amine groups can form covalent bonds with the third polymer where present (described in detail below), thereby aiding the formation of the three-dimensional network where present. Similar, amine groups can form bonds with appropriate chemical groups of the support fibers or with appropriate chemical groups of intermediate molecules used to indirectly bond the first substance to the support fibers. On the other hand, amine groups are also highly useful groups in terms of capturing dye compounds, as will be discussed below. A multitude of amine groups in the first polymer is therefore preferable so that covalent bonds can potentially be formed with the third polymer whilst ensuring that amine groups remain available to aid the capture of dye compounds.

The term ‘amine’ takes on its usual meaning of being a derivative of ammonia in which one, two or three of the ammonia hydrogen atoms has been replaced by a substituent such as an alkyl group. In the special case of a quaternary ammonium group, the three hydrogen atoms are replaced by four substituents, thereby resulting in a cationic tetravalent nitrogen atom. Needless to say, the term amine does not encompass groups that the skilled person would recognize as separate functional groups. For example, those skilled in this field will appreciate that amides, nitriles, sulfonamides, urethanes and so forth are not amines, and polyvinylformamides, poly(meth)acrylamides, poly(meth)acrylonitriles, polyamides, polyvinylsulfonamides and so forth are not examples of the first polymer. On the other hand, the first polymer can include repeating units stemming from monomers that would ordinarily form these non-amine polymers, such as vinylformamide, (meth)acrylamide, acrylonitrile, vinylsulfonamide and so forth, because the first polymer can include non-amine repeating units as mentioned above, provided that the polymer has the mandatory primary and/or secondary amine groups as well.

The first polymer can be water soluble, wherein the water solubility of the first polymer is preferably ≧10 g/liter at 25° C., more preferably ≧40 g/liter at 25° C. The water solubility of the first polymer assists dye-capture and retention because water-solubility implies hydrophilicity, which aids the retention of hydrophilic dyes. Water solubility also aids the production of the laundry aid because the first polymer is conveniently handled in the form of an aqueous solution. Moreover, laundry aids having a three-dimensional network tend to have a better structure when the first polymer is water soluble because, when placed in water, the water soluble polymer chains will tend to exist (by virtue of the swelling phenomenon) with a more open, elongate tertiary structure than polymer chains that are not water soluble, or only sparingly water soluble. The ‘open’ tertiary structure of the polymer chains is helpful because it means that the individual polymer chains are more likely to intertwine with the individual chains of the third polymer (when present) and the fibers of the support, thereby promoting the advantageous entanglement. In contrast, impregnating the support with first polymer chains that have a closed, ball-like tertiary structure will not promote entanglement.

Examples of the first include polymer include poly(allyl amine), polyethylene imine), partially hydrolyzed poly(vinylformamide), polyvinylamide, chitosan and copolymers of these polyamines with any other type of monomers.

The average molecular weight of the first polymer in isolation can be at least 20,000, preferably higher than 100,000, wherein higher molecular weight polymers tend to improve both the structural strength of the laundry aid and its ability to capture dyes. The upper limit of the average molecular weight of the first polymer is not particularly limited, but is generally less than 5,000,000, preferably less than 1,000,000. First polymers having an average molecular weight below these values are preferable because aqueous solutions of these polymers are generally easier to handle, as they are not overly viscous.

The first polymer can also comprise side-chains having quaternary ammonium groups. Adding side-chains that possess such cationic groups can be helpful because they augment the effects explained above regarding the general cationic groups of the first polymer. For example, side-chain quaternary ammonium groups can be obtained by conducting a graft-type reaction on the first polymer using glicidyl trimethylammonium chloride and/or 3-chloro-2-hydroxypropyl trimethylammonium chloride as grafting reactants. For example, these groups can be bonded to amine groups of the first polymer, provided that sufficient amine groups remain for cross-linking and for also capturing dyes. Generally speaking, it is preferable that less than 30% of amine groups of the first polymer are occupied with side-chains having quaternary ammonium groups. This helps to retain a large number of uncapped amine groups for cross-linking and also helps to ensure that the viscosity of the first polymer does not increase to the extent that it is inconvenient to handle when producing the laundry aid.

Further details regarding the first substance are provided below in the passages dealing with the laundry aid as a whole.

Second Substance

The laundry aid comprises a second substance, which is coated upon the first substance. The arrangement of the first substance and second substance in the laundry aid is further discussed below in the section describing the structure of the laundry aid as a whole.

The second substance is a polymer, and is therefore sometimes referred to as the “second polymer” throughout this specification. The second polymer remains substantially coated upon the first substance when the laundry aid is exposed to water over the pH range of from 6 to 10, meaning that the coating formed by the second polymer remains substantially intact during a laundering process. It is preferable, for example, that at least 50% of the second polymer remains coated upon the first substance when exposed to water in the pH range of from 6 to 10 for 60 minutes at 40° C. It is more preferable that at least 70% (and yet more preferable that at least 80%) of the second polymer remains coated after this period under these conditions.

The second polymer can remain substantially coated upon the first substance when exposed to these conditions in a number of ways. For example, the second polymer per se can be soluble in these conditions, but can be secured to the first substance by chemical bonds. Suitable chemical bonds include covalent bonds, ionic bonds, hydrogen bonds and dative covalent bonds, and more than one type of chemical bonding can be employed. In instances where the second polymer is chemically bonded to the first substance, the second polymer can be bonded directly to the first substance or via an intermediate chemical linkage, such as a cross-linking compound that bonds to both the first substance and the second polymer. Suitable bonding modes are the same as described above in relation to the first substance being bonded to the support fibers. The second polymer can also remain in place by other mechanisms. For example, the second polymer can form strong intermolecular interactions with the first substance, which has the effect of anchoring the second polymer to the first polymer. Alternatively, some variants of the second polymer can resist dissolution in the wash liquor under the conditions of a laundering process.

The second polymer includes repeating units comprising a structure according to the following Formula (1):

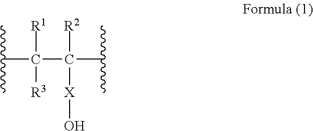

wherein R¹, R² and R³ each independently represents H, a C₁₋₃ alkyl group, a C₂₋₃ alkenyl group, a C₃₋₈ cycloalkyl group, a C₆₋₁₀ aryl group or a C₃₋₆ heterocyclic group, and each of which being optionally substituted with a hydroxyl group; and X represents a covalent bond, a C₁₋₃ alkylene group, a C₃-₆ cycloalkylene group, a C₈₋₁₀ arylene group or a C₃₋₆ heterocyclic group. For example, R¹, R² and R³ each independently represents H or a C₁₋₃ alkyl group optionally substituted with a hydroxyl group; and X represents a covalent bond or a C₁₋₃ alkylene group.

The C₁₋₃ alkyl groups can independently be methyl, ethyl, n-propyl or i-propyl. The C₂₋₃ alkenyl groups can independently be ethenyl, n-propenyl or i-propenyl. The C₃₋₆ cycloalkyl groups can independently be cyclopropyl, cyclobutyl, cyclopentyl or cyclohexyl. The C₆₋₁₀ aryl groups can independently be phenyl or naphthyl. The C₃₋₆ heterocyclic groups can independently be an aziridine ring, an oxirane ring an azetidine ring, an oxetane ring, a pyrrolidine ring, a pyrrole ring, a furan ring, a tetrahydrofuran ring, a thiophene ring, an imidazole ring, an oxazolidine ring, a piperidine ring,a pyridine ring, a pyran ring, a morpholine ring and so forth. Examples of suitable C₁₋₃ alkylene groups, C₃₋₆ cycloalkylene groups and C₆₋₁₀ arylene groups are the same as those outlined above for C₁₋₃ alkyl groups, C₃₋₆ cycloalkyl groups and C₆₋₁₀ aryl groups, except that a further hydrogen atom has been abstracted.

The percentage of repeating units in the second polymer falling within the scope of Formula (1) is preferably ≧50%, more preferably ≧70%, even more preferably ≧80%, and most preferably ≧90%. The repeating units falling within the scope of Formula (1) need not necessarily have the same structure, however.

The repeating unit comprising the structure according to Formula (1) is preferably a repeating unit according to Formula (2):

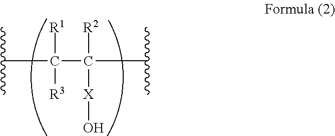

wherein R¹, R², R³ and X are as defined above. The percentage of repeating units in the second polymer falling within the scope of Formula (2) is preferably ≧50%, more preferably ≧70%, even more preferably ≧80%, and most preferably ≧90%. The repeating units falling within the scope of Formula (2) need not necessarily have the same structure, however.

The repeating unit comprising the structure according to Formula (1) or the repeating unit according to Formula (2) is preferably a repeating unit according to Formula (3):

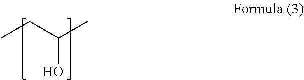

The percentage of repeating units in the second polymer falling within the scope of Formula (3) is preferably ≧50%, more preferably ≧70%, even more preferably ≧80%, and most preferably ≧90%.

Other types of repeating unit in the second polymer are not particularly limited, and can include alkylenes, akylene oxides, esters, carbonates, urethanes, saccharides, (meth)acrylics, carboxylics and vinyl halides. The number average molecular weight of the second polymer is not particularly limited, but can suitably be in the range of 10,000 to 200,000, more preferably 30,000 to 180,000 and most preferably 60,000 to 150,000. The second polymer is preferably a polyvinyl alcohol having a viscosity of at least 5 mPa·s when measured as a 4% w/w aqueous solution at 20° C. and in accordance with DIN 53015, more preferably at least 15 mPa·s and most preferably 20 mPa·s.

Third Polymer

In instances where the first substance is a first polymer that is anchored to the support by way of the three-dimensional network, the laundry aid can also comprise a third polymer. The third polymer is a water soluble polymer that is able to cross-link chains of the first polymer by forming covalent cross-links, which contributes to the structural integrity of the three-dimensional network. These properties, in turn, contribute to the stability of the three-dimensional network before during and after use. Before use, the longevity of the three-dimensional network is manifested in terms of a long shelf-life, for example, because the three-dimensional network will not deteriorate over time. The laundry aid will therefore perform adequately even after being stored for a prolonged period of time. The structural integrity is also beneficial during and after the use of the laundry aid because the laundry aid will not deteriorate and, ultimately, break apart under the mechanical and thermal stress caused by the churning motion of the heated water in a laundry operation.

As will be discussed below, the cross-linking also helps to ensure that the three-dimensional network is insoluble in water.

Particularly useful embodiments of the laundry aid are those in which the first polymer is a water-soluble polyamine comprising primary amine groups and is anchored to the support as part of a three-dimensional network entangled with at least some of the fibers contained in the support, and the three-dimensional network comprises the first polymer cross-linked by a third polymer, the third polymer being a water soluble polymer that is different from the first polymer and comprises repeating units comprising halohydrin and/or epoxide groups that are capable of forming covalent cross-links with the primary amine groups of the first polymer.

Both primary (R—NH₂) and secondary (R—NH—R′) amine groups—with R and R′ representing a carbon covalent bond—can react with the halohydrin and/or epoxide group of the third polymer to form covalent bonds. Primary amine groups can react with two reactive groups of the third polymer, forming two covalent bonds, since a primary amine group has two labile hydrogens. Secondary amines have one labile hydrogen and can thus form only one covalent bond by reacting with the third polymer. Hence the potential reactivity between functional groups can be defined in terms of the number of labile hydrogen atoms on the nitrogen atom of the amine group (i.e. the number of reactive N—H functions). In other words, the number of reactive N—H functional groups corresponds to the number of possible covalent bond that the amine groups can form. The number of moles of the (N—H) functional group can be calculated as follows: the number of moles of the (N—H) functional group is equal to the number of moles of secondary amine group+two times the number of moles of primary amine groups.

In these embodiments, the third polymer is able to form covalent cross-links with the first polymer because the third polymer contains halohydrin and/or epoxide groups. Halohydrin groups are characterized by the presence of a hydroxyl group and a halogen functional group on adjacent carbon atoms. The halogen can be any of fluorine, chlorine, bromine and iodine, for example. Chlorohydrin groups are particularly useful halohydrins within the scope of the present invention because they are readily obtainable and readily form cross-links with the first polymer. For example, the chlorohydrin illustrated in the following Formula (A) can be used in the laundry aid of the present invention:

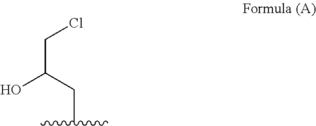 [SMILES: *CC(O)CCl]

wherein the zig-zag line indicates the point at which this chlorohydrin group is joined to the Third polymer.

The mechanism by which the halohydrin groups, such as the one illustrated in Formula (A), form covalent cross-links with the first polymer is not particularly limited. In one mechanism, the halogen atom can be displaced by reaction with a nucleophilic group of the first polymer. In a related mechanism, the halohydrin groups can form an intermediate epoxide group via intramolecular nucleophilic attack by the hydroxyl group of the halohydrin group on the halogen group, and the newly-formed epoxide group can then react with nucleophilic groups of the first polymer.

Epoxide groups are characterized by the presence a three-membered cyclic ether. As a result of the ring-strain within the epoxide ring, epoxide groups tend to be more reactive than other cyclic ethers, which aids the formation of cross-links. For example, this ring strain can render the epoxide ring more labile towards nucleophilic attack from nucleophilic groups of the first polymer.

Whereas the first polymer can be characterized by the average number of N—H functional groups in its polymer chains, the third polymer can be characterized by the average number of halohydrin and/or epoxide functional groups in its polymer chains.

The average molecular weight of the third polymer in isolation is not particularly limited. However, it is helpful if the average molecular weight is at least 1,000, preferably higher than 20,000, as this improves the structural integrity of the three-dimensional network within the laundry aid. Structural integrity can be manifested in terms of the tensile strength of the laundry aid. It is also helpful if the average molecular weight is lower than 5,000,000, preferably less than 1,000,000. Third polymers having an average molecular weight below these values are preferable because aqueous solutions of these polymers are generally easier to handle, as they are not overly viscous.

The third polymer is water soluble, wherein the water solubility of the third polymer is preferably ≧1 g/liter at 25° C., more preferably at least 3 g/liter at 25° C. The water solubility of the third polymer aids the production of the laundry aid because it is conveniently handled in the form of an aqueous solution. Moreover, the resulting three-dimensional network tends to have a better structure when the third polymer is water soluble because, when placed in water, the water soluble polymer chains will tend to exist (by virtue of the swelling phenomenon) with a more open, elongate tertiary structure than polymer chains that are not water soluble, or only sparingly water soluble. The open tertiary structure of the polymer chains is helpful because it means that the individual polymer chains are more likely to intertwine with the individual chains of the first polymer and the fibers of the support, thereby promoting the necessary entanglement of the various fibers and polymer chains present. In contrast, impregnating the support with third polymer chains that have a closed, ball-like tertiary structure will not aid entanglement. The mutual water solubility of both the first and third polymers is also helpful because the polymers will form favorable intermolecular interactions, which further promotes close intertwining and aids cross-linking.

The type of polymer used as the third polymer is not particularly limited, provided that it possesses the necessary halohydrin and/or epoxide groups. This versatility of the third polymer is yet another advantage associated with the present invention. Moreover, epoxide and/or halohydrin groups can be added to a pre-made polymer in a straightforward manner, which provides convenient access to a multitude of alternatives within the scope of the third polymer. For example, the halohydrin illustrated in Formula (I) above can be readily formed by reacting a polymer containing nucleophilic groups with epichlorohydrin.

Suitable types of polymers for use as the third polymer include polyamides, polyalkanolamines, polyamines fully reacted with halogen compounds such as epichlorohydrin, modified polydiallyldimethylammonium chloride, polyamines, polyalkenes, polyalkylene oxides, polyesters, poly(meth)acrylic acids) and copolymers thereof.

The third polymer can also comprise quaternary ammonium groups, which help to capture anionic dye compounds, such as acid dye compounds, that are typically used to dye fabrics. Such quaternary ammonium groups can, for example, be present in the polymer backbone, in the repeating units and/or in side-chains. The quaternary ammonium groups can be present in the same polymer chain as either the halohydrin groups or the epoxide groups mentioned above, or both the halohydrin groups and the epoxide groups; there is no particular limit in this regard. By way of an example, the third polymer can be a diallyl(3-chloro-2-hydroxypropyl)amine hydrochloride-diallyldimethylammonium chloride copolymer having the repeating units illustrated in following Formula (B):

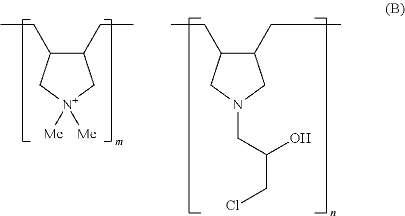

wherein the ratio of m:n in the polymer is in the range of from 1:9 to 9:1, preferably from 4:6 to 6:4. The average molecular weight is preferably higher than 1,000, more preferably higher than 20,000, and the average molecular weight is preferably lower than 5,000,000, more preferably lower than 1,000,000.

Further details regarding the third polymer are provided below in the passages dealing with the laundry aid as a whole.

Further Components

The laundry aid material can also include further components as desired by the user. For example, the user might choose to add a binder in order to aid structural integrity. Examples of binders include acrylics, vinyl esters, vinyl chloride alkene polymers and copolymers, styrene-acrylic copolymers, styrene-butadiene copolymer, urethane polymers, and copolymers thereof, wherein vinyl acetate and/or ethylene vinyl acetate copolymers are particularly useful. Preferably said binder is a self-cross-linkable binder, e.g. with pendant cross-linking functionalities. Preferably the binder is hydrophilic. The binder can also contain starch or polyvinyl alcohol. The amount of binder present, if desired by the user, can be generally in the range of from 5 to 50 g/m² of the surface of the laundry aid. However, the present invention does not explicitly require a binder because the first substance and second polymer impart significant structural strength to the laundry aid. Embodiments in which the first substance is a first polymer anchored to the support as part of an entangled three-dimensional network with the third polymer provides particularly significant structural strength. The innate structural strength of the present laundry aid is a further significant benefit of the present invention because traditional laundry aids normally require the addition of a binder in order to reach acceptable levels of structural strength.

The laundry aid can also contain heat-sealable components, such as a hot-melt adhesive, that allow the laundry aid to be heat-bonded. For example, the laundry aid can comprise thermoplastic fibers having melting temperatures less than 150° C. such as polyethylene or copolymers of polyesters, or bicomponent fibers possessing this capability. This enables portions of the laundry aid containing this component to be heat-bonded to another article and/or another portion of the laundry aid. For example, a sheet-like laundry aid can have a heat-sealable component around its perimeter, which enables the sheet to be heat-sealed to a similar sheet in order form a pouch or sachet. In a different approach, a sheet-like laundry aid can have a heat-sealable component around its perimeter can be folded in two and the corresponding portions having a heat-sealable component can be bonded together to form a pouch or sachet.

Additional components that can form part of the laundry aid include laundry detergents, antimicrobial components, bactericides, perfumes, brighteners, softeners, detergents, water-softening agent and/or surfactants, wherein the surfactants can, for example, be anionic, cationic, zwitterionic or nonionic. The amounts of these components present in the laundry aid is not particularly limited, and can, instead, be determined by the user according to their preferences.

Laundry Aid

As mentioned above, the present invention is directed to a dye-capturing laundry aid comprising a fiber-containing support, a first substance and a polymeric second substance (sometimes referred to as the ‘second polymer’). The fiber-containing support provides a scaffold that immobilizes the dye-capturing first substance and the second substance forms a coating on the first substance. The structure of the support is therefore conceptually a layered structure, as the first substance is present on and around the support fibers and the second polymer is coated on the first substance.

As the support fibers often form a three-dimensional porous scaffold, the first substance can be anchored within the matrix formed by the support fibers in addition to being anchored on the outer surfaces of the support since the first substance will penetrate into the porous scaffold during the step of contacting it with the support. The ‘layer’ formed by the first substance can therefore penetrate into the gaps between the fibers to some extent. This is tolerated because it does not prevent the laundry aid from acting satisfactorily. Although the first substance needs to be anchored to the support fibers, the support fibers do not need to be entirely covered by the first substance, as the support merely provides a scaffold to which the first substance is anchored. Accordingly, the first substance does not need to form a complete ‘layer’ coating the support, as this would depend upon factors such as the amount of first polymer present per unit area of the support. On the contrary, the first substance can be anchored to the support in a pattern, so that captured dye molecules provide a visual aid to the user in the form of a pattern. This pattern could take the form of a brand name, for instance.

As the first polymer does not need to fully encapsulate the support fibers, some of the second polymer might coat the support fibers rather than the first polymer. Again, this is not a problem. Similarly, the second polymer might not fully coat the first substance, although it is preferable that as much of the first substance is coated as possible in order to improve the dye-capturing capability of the present laundry aid. Therefore, whilst the laundry aid generally has a layered structure of support fibers|first substance|second substance, the structure can locally deviate from this concept to some extent.

The coverage amounts of the first substance and second polymer are not particularly limited. The coverage amount of the first substance, such as the first polymer, can be in the range of from 1.0 to 30.0 g/m², more preferably from 5.0 to 20.0 g/m². The coverage amount of the second polymer can be in the range of from 1.0 to 30.0 g/m², more preferably from 5.0 to 20.0 g/m².

As mentioned above, the first substance can be anchored to the support in a manner of ways, one of which is to form a three-dimensional network around the support fibers, wherein the first substance is a first polymer that is cross-linked by a third polymer. The discussion of the structure of the laundry aid above applies equally to embodiments having the third polymer, wherein the mention of the first polymer in the description above equates to the three-dimensional network formed from the first and third polymers.

When the first and third polymers are present, the mass ratio of the first polymer to the third polymer can be in the range of from 99:1 to 20:80, preferably from 97:3 to 50:50. This ratio helps to provide the three-dimensional network with structural strength and insolubility whilst retaining good dye-capture and dye-retention properties. However, it can be more helpful to define the relative amounts of the first and third polymers by their respective average molecular amounts of reactive functional groups, i.e. (N—H) reactive functional groups for the first polymer, and halohydrin and/or epoxide reactive functional groups for the third polymer. It can be advantageous that the first and third polymers are present in relative amounts such that the relative molecular ratio of the halohydrin and/or epoxide functions to the (N—H) functions in the range of from 0.0035 to 0.0380. Without wishing to be bound by theory, it is believed that this ratio is preferential because the resulting three-dimensional network will have high strength, very low water-solubility and a high degree of dye retention.

In another embodiment, the molecular ratio of the halohydrin and/or epoxide functional groups in the third polymer to the (N—H) functional groups in the first polymer is in the range of 0.0035 to 1.0000 when the third polymer also contains quaternary ammonium groups as described earlier, more preferably in the case where the third polymer also has groups according to the Formula (B). Without wishing to be bound by theory, it is believed that the range of ratios for this embodiment can be broader than the range of ratios in the previous paragraph because the third polymer in this embodiment contains quaternary ammonium groups that can contribute to retaining dye compounds.

The three-dimensional network can have a basis weight of from 0.5 to 30.0 g/m², more preferably from 1.0 to 20.0 g/m². For the avoidance of doubt, these ranges refer to the total dry mass of the first and third polymers and are based upon the area of one side of the sheet. Whilst traditional laundry aid treatments have typically been applied heavily on a substrate, this is not necessary with the three-dimensional network used in the present invention because it very efficiently captures dyes even when present in relatively small amounts. This represents a significant cost-saving to the would-be manufacturer since less raw materials are required.

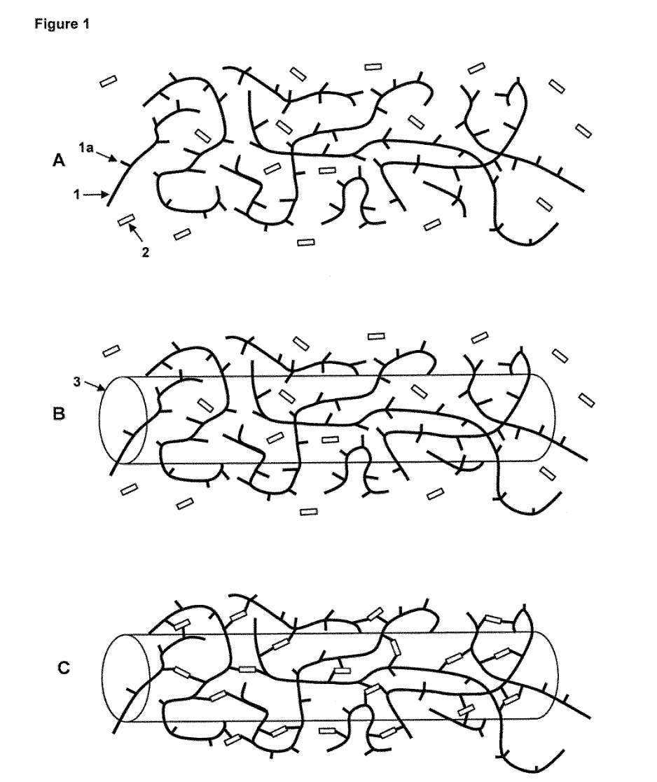

FIG. 1C depicts a small section of the structure notionally formed by entangling three-dimensional network with a support fiber, wherein a support fiber 3 is shown as being entangled with the three-dimensional network comprising the first polymer 1 cross-linked by the third polymer 2 by virtue of the amine groups 1 a. Needless to say, FIG. 1C does not show the full extent of the entanglement because, to avoid undue complexity, it depicts only a small region around a portion of just a single support fiber. In reality, the support fibers and the chains of the first polymer will extend a distance though the material, and would therefore intertwine with neighboring support fibers and first polymer chains to form a matrix of different fibers and polymer chains. The cross-links formed by the third polymer serve to glue the support fibers and first polymers together in the entangled matrix of fibers and polymer chains,

The entangled mixture comprising fibers of the support and the three-dimensional network of first and third polymers is such that, without the cross-links, the fibers, first polymer chains and third polymer chains would resemble a web of individual support fibers and polymer chains of the first and third polymers. When viewed on a microscopic scale, the non-cross-linked mixture of support fibers and polymer chains would appear as an intricate matrix of strands not unlike cooked spaghetti. However, the cross-links present within the three-dimensional network drastically alter the properties of the entangled mixture because the cross-links restrict the movement of the first and third chains in the matrix, relative to the support fibers. This restriction of movement is thought to occur because the entwined mixture of support fibers, first polymer chains and third polymer chains are knitted together by the cross-links, such that the three-dimensional network becomes anchored around the numerous fibers of the support.

As will be understood from the above description, the cross-links in the three-dimensional network do not need to prevent all movement of the support fibers, first polymer chains and third polymer chains. For example, there will generally be a degree of freedom of movement on a relatively local scale, i.e. short range movement, since the various strands of polymeric chains/support fibers will be able to ‘wriggle’ and bend etc. with the entangled matrix. However, the cross-links suppress long-range movement of the various components within the entangled mixture of support fibers and polymer chains because the polymer chains and the support fibers are knitted together in the matrix. Accordingly, the polymer chains and support fibers are incapable of completely escaping the laundry aid because the first polymer chains surrounding the support fibers are stitched/glued together by the cross-links provided by the third polymer. In essence, the cross-links secure the entanglement.

The restriction of long range movement in the entangled mass is particularly useful with respect to the first polymer because the positively-charged first polymer, which is capable of binding to dye molecules, is firmly anchored with the entangled mixture of the laundry aid. Therefore, dyes that are captured by the first polymer during use will also be firmly anchored by the laundry aid, Needless to say, this effect also applies to other components of the entangled mass that are able to capturing dyes, such as the third polymer, because these other components are similarly anchored by entanglement and cross-linking. An important advantage of the crosslinking reaction reported in the present invention is the fact that the formed cross-links are not hydrolysable even under severe conditions.

The relative arrangement of fibers, first polymer chains and third polymer chains is not particularly limited. For example, the fibers of the support can be deliberately arranged, such as being woven in place or the support fibers can be distributed randomly (e.g. the support is a nonwoven web). In either case, the intertwining first polymer chains will surround the support fibers and will be held in place by the cross-links provided by the third polymer.

The entanglement/cross-linking can be described in various ways. For example, this can be expressed in terms of the insolubility of the first polymer in the laundry aid, which is based upon the concept that first polymer chains anchored within the three-dimensional network by cross-linking will not be able to dissolve when the laundry aid is immersed in water. Without wishing to be bound by theory, it is believed that chains of the first polymer can potentially escape the three-dimensional network by at least two mechanisms. On the one hand, first polymer chains that are not cross-linked by the third polymer will not be as securely anchored by network, and will therefore potentially be able to escape. On the other hand, it is possible, though highly unlikely, that cross-links will be hydrolyzed by immersion of the laundry aid in an aqueous medium, and so a first polymer chain that has been freed of all cross-links will also have the potential to escape the laundry aid. An important advantage of the cross-linking in the laundry aid is that the cross-links are not hydrolysable under even the most severe washing conditions that the laundry aid is likely to encounter during use. Accordingly, it is highly unlikely that the three-dimensional network will break down under the stresses of everyday, normal use.

For example, the insolubility of the first polymer after cross-linking can be expressed in terms of the following titration test, but this should not be construed as an essential feature of the present invention. More specifically, the titration requires that a pH 6.5 aqueous composition that has been obtained by immersing 50 g of the laundry aid in one liter of water at 70° C. for 10 minutes requires ≦3 mmol of NaOH to raise the pH of the aqueous solution from 6.5 to 10.5 at 25° C. Preferably, the amount of NaOH required is ≦2.5 mmol, and more preferably ≦2 mmol.

This test is, therefore, based upon the concept that amines that have escaped the laundry aid during immersion in water will be protonated at pH 6.5. Accordingly, the amount of NaOH required to increase the pH from 6.5 to 10.5 will indicate the extent to which amines have escaped the laundry aid during immersion of the laundry aid in water and therefore remain in the aqueous composition after the laundry aid has been removed. Of course, it will be appreciated that the titration test will also take into account other substances in the aqueous composition that undergo an acid-base reaction in the pH range of 6.5 to 10.5.

By way of example, the following combinations of first and third polymers are just some of the many ways in which to achieve the level of insolubility described above by the titration test:
The first polymer is a polyvinylamine having an average molecular weight in the range of 100,000 to 750,000, the third polymer is an epichlorohydrin-modified polyamide having an average molecular weight in the range of from 5,000 to 100,000, the mass ratio of the first and third polymers is in the range of from 97:3 to 75:25, and optionally wherein the ratio of chlorohydrin groups to the N—H groups between the third and first polymers is in the range of from 0.0035 to 0.0380.
The first polymer is a polyethyleneimine having an average molecular weight in the range of 100,000 and 1,000,000, the third polymer is a polymer having both quaternary ammonium groups and epichlorohydrin groups and has an average molecular weight in the range of from 5,000 to 200,000, the mass ratio of the first and third polymers is in the range of from 97:3 to 50:50, and optionally wherein the ratio of chlorohydrin groups to the N—H groups between the third and first polymers is in the range of from 0.0035 to 1.0000.
The first polymer is a polyallylamine comprising quaternary ammonium groups and has an average molecular weight in the range of 100,000 and 1,000,000, the third polymer is a polymer having both quaternary ammonium groups and epichlorohydrin groups and has an average molecular weight in the range of from 5,000 to 200,000, the mass ratio of the first and third polymers is in the range of from 97:3 to 75:25, and optionally wherein the ratio of chlorohydrin groups to the N—H groups between the third and first polymers is in the range of from 0.0035 to 0.0380.

An alternative and/or additional way of expressing the insolubility of the first polymer in the laundry aid is a UV-Vis absorbance spectrum method, wherein the extent to which the first polymer can escape the laundry aid is assessed by detecting complexes formed between the first polymer and a dye compound.

In addition, the laundry aid can take the form of a porous envelope/sachet surrounding an inner chamber. This arrangement can, for example, be obtained by preparing a porous sheet-like laundry aid and heat bonding the perimeter of the sheet to another substrate. For example, heat-bonding the perimeter of such a sheet-like laundry aid to another a porous sheet of the laundry aid would result in complete article resembling a tea-bag, though not necessarily of similar size. Hence the envelope/sachet is porous to water without being soluble in water. The latter type of article has the benefit of being able to accommodate useful materials within the chamber formed by the laundry aid, such as detergents, softeners and so forth. Buoyancy aids can also be housed in the inner chamber so that the laundry aid has a tendency to float in the wash liquor.

Process of Producing Laundry Aid

The process by which the laundry aid is produced is not particularly limited, which is a further benefit of the present invention. However, one useful method of producing the laundry aid includes the steps of:
(i) anchoring the first substance to the support; and
(ii) coating the first substance with the, second substance.

Performing the steps in this order helps to ensure that the second substance forms an outer coating on the first substance, which delivers the improved dye-capturing capability of the laundry aid.

The process by which the first substance is anchored to the support is not particularly limited, which is a further benefit of the present invention. If the first substance is anchored by being chemically bonded to the support, then a useful production method involves impregnating the support with a liquid composition comprising the first substance in order to facilitate the chemical bonding reaction. The impregnation step itself can be implemented by soaking the support in the impregnation composition or by using the padding technique discussed below, for example. The chemical bonding reaction can be encouraged by heating the impregnated support, which accelerates the bonding reaction by imparting thermal energy to the reactive components and by driving off any residual volatile components from the impregnation composition, thereby encouraging the reactive components to come into intimate contact which one another. If the chemical bonding is to take place via an intermediate chemical species, such as a cross-linker, then this additional component can be incorporated into the impregnation composition.

If the first substance is anchored to the support using a three-dimensional network comprising a first polymer (as the first substance) and a third polymer, then a useful method of anchoring the first substance to the support includes the steps of:
(a) sequentially or simultaneously impregnating the fiber-containing support with the first polymer and the third polymer; and
(b) cross-linking the first polymer with the third polymer in the support to form the three-dimensional network of cross-linked first and third polymers.

The method by which the fiber-containing support is impregnated with the first and third polymers is not particularly limited. For example, the fiber-containing support can be soaked in a solution, such as an aqueous solution, of each polymer separately or a solution containing both polymers together. However, it can be preferable to impregnate the support with a solution containing both the first and third polymers, as this will help to maximize mixing between the two polymers, and therefore enhance entanglement and cross-linking.

Impregnation can also be achieved by a so-called padding technique, wherein the fiber-containing support is contacted with a solution of the first and third polymers (or separate solutions of the first and third polymer, either sequentially or simultaneously) before being passed through nip rollers. The squeezing action of the rollers helps to force the solution of first and/or third polymers deep into the fiber-containing support, such that the resulting cross-linking causes a high level of entanglement with the fibers of the support. Since the squeezing action of the rollers causes deep impregnation of the first/third polymers, then the method by which the solution of the first and/or third polymers is initially contacted with the fiber-containing support is not particularly limited. Non-limiting examples of this the contacting step include spraying the support with the polymer-containing solution(s) or immersing the support in the polymer-containing solution(s).

Various other components can be added prior to or simultaneously with the first and/or third polymers. For example, when using a particularly hydrophobic support, such as a polyalkene support, it can be helpful to use a wetting agent in order to aid penetration of the hydrophilic first and third polymers deep into the support. This can also be useful if the first and/or third polymers are applied in the form of an aqueous solution.

Cross-linking can be conducted by any appropriate means. In many cases, due to the close proximity of the reagents and the types of reacting functional groups involved, cross-linking occurs spontaneously by ageing. If desirable, it can be helpful to promote cross-linking by heating/curing the impregnated support so as to thermally promote cross-linking. Any other conventional way of increasing the rate of reaction can also be used to promote cross-linking, such as photochemical rate acceleration.

In addition, cross-linking can be promoted by creating an alkaline environment in the laundry aid. For example, this can be achieved by impregnating the support with an alkaline solution of the first and/or third polymers. An alkaline environment can assist cross-linking by a number of ways. On the one hand, and alkaline environment helps to make amine groups of the first polymer more nucleophilic, and therefore more reactive towards the cross-linking groups of the third polymer. On other hand, the alkaline environment can help to absorb acidic byproducts of the cross-linking reaction that might otherwise retard further cross-linking. For example, the putative byproduct formed by reacting an amine with a halohydrin group is HCl, but this would be consumed by an alkaline environment. Any alkalinity remaining after the cross-linking reaction can be removed by, for example, washing with water, but this is not strictly necessary since the laundry aid will be washed in situ during use, thereby providing the necessary cationic environment for use.

The sequence of events described above is illustrated in FIG. 1, wherein FIG. 1A depicts a solution containing first polymer 1 and third polymer 2, FIG. 1B depicts the support impregnated with the first and third polymers prior to cross-linking, and FIG. 1C depicts the cross-linked three-dimensional network entangled with the support. As mentioned above, FIG. 1 depicts only a small portion of the entangled mixture of support fibers and three-dimensional network in order to avoid undue complexity. As can be understood from FIG. 1B, impregnating the support with the first and third polymers caused them to pass between and surround fibers within the support. Then, once cross-linking occurs between the third polymer 2 and the amine groups 1a of the first polymer 1, the first fibers are locked in place between and around the support fibers.

It can also be helpful to dry the impregnated support, since this will help to remove water that might remain from the impregnation step. The drying step can be conducted by exposing the impregnated support to elevated temperatures for a period of time, wherein shorter drying times are generally associated with higher temperatures. As a guide, drying can be conducted by exposing the impregnated support to temperatures of 50-150° C. for 0.5-30 minutes. Drying can also be promoted by exposing the impregnated support to a vacuum during drying, wherein drying in a vacuum generally requires lower drying temperatures than when drying at ambient pressure. Of course, the drying step will itself also help to promote cross-linking. Moreover, the drying step can be conducted before, during or after the cross-linking step.

The method by which the second polymer is coated upon the first substance is not particularly limited. One suitable method is to impregnate the product of step (i) above with a liquid composition containing the second polymer, wherein suitable impregnating techniques are those described above in respect of impregnating the first and third polymers. Another suitable method is to coat the product of step (i) above with a liquid composition containing the second polymer, wherein suitable coating techniques can be any coating process known in the art like bar, knife, air-knife, roll, gravure and screen coating. Coating can be done on the both faces or only on one face.

It can be helpful to dry the laundry aid following impregnation/coating with the second polymer with the aid of heating and/or vacuum in order to remove residual impregnating/coating composition and to encourage chemical bonding if this is desired. It can also be helpful to dry the laundry aid prior to applying the second polymer, as this encourages the formation of the layered structure (i.e. the coating of the second substance on the first substance) for a number of reasons. For example, drying the laundry aid removes volatile components of the composition used to apply the first substance, which has the effect of bringing the first substance into intimate contact with the support fibers so that the first substance forms a cohesive layer upon which the second substance can be coated. Drying the laundry aid also encourages the anchoring of the first substance to the support, such as by forming chemical bonds with the support or by forming crosslinks between separate molecules of the first substance and/or with the third polymer. Drying the laundry aid also removes the volatile components of the composition used to apply the first substance from the pores formed between the support fibers, which encourages the composition containing the second polymer to penetrate deep into the support, thereby forming a more complete coating of the first substance.

The sheet-form laundry aid can also be formed into more complex structures, such as a water-porous sachet or pouch such that additives housed within the sachet or pouch can also play a part in the laundering process. Additives suitably housed within the sachet or pouch include those listed above as potential additives of the laundry aid in general.

The way in which the sheet-like laundry aid can be converted into the sachet/pouch is not particularly limited. For instance, the sheet-like laundry aid can be folded in two and secured along their periphery of the sides with suitable additives enclosed therein the so-formed pouch or sachet. Alternatively, the wall of the bag or sachet may consist of two sheets of the laundry aid secured together about their periphery with the additive enclosed therein. An optional variant of the second approach is to attach one sheet of the laundry aid to another type of sheet altogether by sealing the periphery of the laundry aid to the other material, provided of course that it is suitable for use in a laundering operation. The method by which the various seals/joins can be made to form the sachet or pouch is not particularly limited, but such a seal/join can be made using thread and/or the heat-sealable component mentioned above.

Use of Laundry Aid

As mentioned above, the laundry aid of the present invention is able to capture dyes from an aqueous medium, which is thought to occur by the laundry aid intercepting the dyes as they move around the aqueous medium. In essence, it is believed that dye molecules, particularly acid dye molecules, coming into close proximity with the laundry aid will experience an intermolecular attraction with appropriate chemical groups of the laundry aid, wherein the appropriate groups of the laundry aid will typically include cationic groups of the first substance and, optionally, the third polymer. As mentioned above, cationic groups can possess a permanent cationic charge, such as a quaternary ammonium group, or may have a cationic charge when operating under typical laundry conditions, such as an amine group. Once this intermolecular attraction has taken effect, the dye molecule will be held in place by the laundry aid because the appropriate groups of the first substance and third polymer are anchored to the laundry aid as described above.

The second polymer improves the dye-capturing performance of the laundry aid during a wash cycle even though the second polymer notionally forms a barrier between the first substance and the fugitive dye molecules in the wash liquor. Without wishing to be bound by theory, this is thought to occur by reducing the extent to which other anionic species in the wash liquor, such as anionic surfactants forming part of the detergent, are captured by the laundry aid. By reducing the extent to which this competitive binding occurs, the ability to capture fugitive dye molecules is improved.

The laundry aid of the present invention is particularly well-suited to capturing direct dyes, which are sometimes termed substantive dyes. These types of dyes do not react with the material to be colored (unlike reactive dyes, for instance) and do not use a mordant, but instead rely upon intermolecular forces in order to adhere to the dyed material. For example, direct dyes are frequently used when dying household fabrics such as cotton. However, the lack of a chemical bond can mean that direct dyes tend to dissociate from the dyed fabric, and so these types of dyes are frequently associated with unwanted color runs during laundering. Moreover, direct dyes tend to have anionic character in the form of a negative charge (such as a sulfonate group) or polarized groups that have anionic character, such as the carbonyl function within an amide group. These types of direct dyes are particularly susceptible to capture by the laundry aid of the present invention since the cationic groups are able to form electrostatic interactions and/or hydrogen bonds with the anionic or anionic-type groups of direct dyes.

The laundry aid can be used to capture dyes during the laundering of fabrics, textiles, clothing and so forth by simply placing the laundry aid in the washing apparatus along with the items to be laundered prior to commencing laundering. The laundry aid will then capture dyes liberated by the aqueous wash medium during the laundering cycle and therefore reduce the likelihood of unwanted ‘color runs’. Visual inspection of the laundry aid after use will tend to reveal whether dyes have been captured because the laundry aid will discolor. It is therefore helpful if the laundry aid has a pale color, preferably white, because this will enable facile visual detection of dye capture and therefore reassure the user that the laundry aid is functioning properly.

### EXAMPLES

The present invention will now be illustrated by way of the following experimental Examples, but these should not be interpreted as limiting the scope of the present invention.

Test Methods

Dry Tensile Strength:—Measurements were taken according to TAPPI Standard T494 om-96 using an MTC500L dynamometer (supplied by Ingeniera Y Desarrollo de Maquinas S. L.) and with the following settings: 50 mm strips were used, the initial jaw distance was 127 mm, and the break force value was recorded as the maximum of the recorded force curve. Elongation values were recorded at 75% of maximum force. Tensile strength is expressed as an arithmetic average of machine direction and cross direction. All testing was conducted under laboratory conditions of 23.0±1.0° C. and 50.0±2.0% relative humidity, and after equilibrating the samples under these conditions for at least 24 hrs.

Wet Tensile Strength:—Measurements were taken according to the same test method as for the Dry Tensile Properties described above, except that sample strips were first immersed in a water bath at a depth of 20 mm for 10 min, followed by removing excess water by placing the immersed sheet between two pieces of absorbent paper (e.g. blotter paper 0903F available from Fioroni) with no pressure applied. Wet/dry ratio is defined as the average wet tensile strength divided by the average dry tensile strength.

Dye Pick-Up (DPU):—A 250×125 mm (312.5 cm²) sheet was placed in one liter of a vigorously agitated aqueous dye solution heated to 40° C., wherein the dye solution comprised direct red dye (Indosol Red BA P 150 from Clariant) at a concentration of 200 mg/liter in deionized water. The sample was removed after 3 minutes and a 10 mL aliquot of the dye solution was diluted to a total volume of 200 mL in readiness for measurement. The absorbance of the diluted aliquot was measured at the maximum absorbency wavelength of Indosol Red BA P 150 (526 nm) using a calibrated Perkin Elmer Lambda 20 spectrophotometer.

A standard calibration curve was used to convert the absorbance value at 526 nm into a value for the concentration of dye in solution (Beer-Lambert Law c=A/[ε×l]; where c=dye concentration, A=absorbance, E=molar absorption coefficient, and l=optical path length). The Dye pick-up (DPU) value is the difference between the concentration of dye measured before and after the immersion of the sample sheet in the solution. The DPU is determined as the amount of dye removed from the solution and adsorbed by the sample sheet, and is expressed in mg of dye per sample sheet (the area of the tested sheet is 312.5 cm² unless otherwise stated). The DPU values are reported as the average value obtained by testing three separate sheets.

In certain instances highlighted in the Examples below, the DPU is measured using a dye solution that contains detergents and/or surfactants selected from those listed in Table 1. Their concentration, when present, is expressed in g/L.

TABLE 1
Detergents and surfactants used for DPU measurements

| Component | Type | Name | Supplier |
|---|---|---|---|
| Detergent | Powder detergent | X-tra | Henkel |
| Detergent | Liquid detergent | Persil | Unilever |
| Surfactant | Non-ionic fatty alcohol ethoxylate | Fluowet | Archroma |
| | C12-15:7EO | UD | |
| Surfactant | Anionic secondary alkyl sulfonate | Hostapur | Archroma |
| | | SAS | |
| Surfactant | Sodium dodecyl benzene sulfonate | SDBS | Sigma |
| | | | Aldrich |
| Surfactant | Sodium dodecyl sulfate | SDS | Sigma |
| | | | Aldrich |

TABLE 2
Detergent surfactant components

| Detergent surfactant composition | X-tra | Persil |
|---|---|---|
| Dry content | 94.9% | 18.8 +/− 4.6% |
| Alkyl ether sulfate | <0.05% | 3.7% |
| Alkyl benzene sulfonate | 7.4% | 5.5% |
| Fatty alcohol ethoxylated | 1.8% | 8.2% |

In certain instances highlighted below, the sample sheet is pre-washed prior to conducting the DPU test. Pre-washing consists of immersing the sheet (the area of a tested sheet is 312.5 cm² unless otherwise stated) in 1 liter of deionized water with the specified detergents or surfactants for 10 minutes at 20° C. The sheet is then dried on a hot plate at 110° C. for 2 minutes.

Washing machine tests: Tests were conducted using a Classixx 7 Vario Perfect WAE24272FF washing machine available from BOSCH, which is a frontal door model with a 7 kg load capacity. The laundry aid sheet (25 cm×12.5 cm unless otherwise stated) is placed inside the drum of the washing machine along with a 5 g swatch of a dyed blue cotton fabric. The blue fabric had a basis weight of 100 g/m² and had been prepared by dyeing a 100% cotton fabric with Direct Blue 71 in Jigger dyeing equipment (cotton fabric available from l'Institut Francais du Textile et de l'Habillement). This blue dye cotton fabric has a color fastness at 60° C. of 2 according to the standard EN ISO 105-C06. The specified amount of detergent is added in the detergent holding part of the machine and the washing machine is operated on a cotton cycle (temperature of 60° C., spinning speed of 1200 rpm).

Color Lab index: The color index HUNTER Lab was measured using an Elrepho 3300 spectrophotometer obtained from Datacolor with C illuminant at 2° angle and with XLAV and UV filters included.

Basis weight: Basis weight was measured according to the ISO536:1997 standard on a 100 cm² area. The results are expressed in g/m2.

Handle-o-meter: Stiffness Handle-o-meter was measured according to TAPPI T498 cm-85 using a 10 mm gap on the Handle-o-meter equipment (Model 211-300 available from Thwing-Albert Instrument Co.).

Whiteness: Whiteness was measured according to the EDANA-INDA harmonized standard WSP 060.3.R3 on an Elrepho 3300 spectrophotometer from Datacolor.

Bending stiffness: Bending stiffness was measured according to ISO 2493 on a Buchel van der Korput B. V. instrument.

Trapezoidal tear: Trapezoidal tear was measured according to the ASTM D5733 standard on a model 1122 dynamometer from Instron. The distance between the jaws was 25 mm, the length of test strips was 25 mm pre-cut in the middle, 50 mm on the other edge and with a traction speed of 100 mm/minute.

### Example 1

### Cationic Laundry Aids

A cationic laundry aid (Nonwoven A) was produced on a wetlaid nonwoven industrial machine, based upon a 52 g/m² fibrous matt comprising a blend of 67% cellulose (softwood Sodra Blue 90Z) and 33% viscose (Kelheim Danufil KS 1.7dtx×8 mm). The fibrous matt was impregnated with 8.0 g/m² of a polyvinylamine (average molecular weight of 340,000, wherein <10% of the amine groups are capped with formyl groups) and an epichlorohydrin-modified polyimide polymer (Giluton 1100-28N from BK Giulini) in a dry ratio 95:5 using a size-press process.

Two additional cationic laundry aids were used in the Examples below. Nonwoven B is a nonwoven comprising a blend of cellulose and viscose, wherein at least the viscose fibers are modified to have cationic moieties. Nonwoven C is a spunlace nonwoven comprising a blend of viscose fibers and polyethylene/polypropylene bi-component fibers, wherein the viscose fibers are modified to have cationic moieties.

### Example 2

### Effect of Surfactants on DPU of Untreated Cationic Laundry Aids

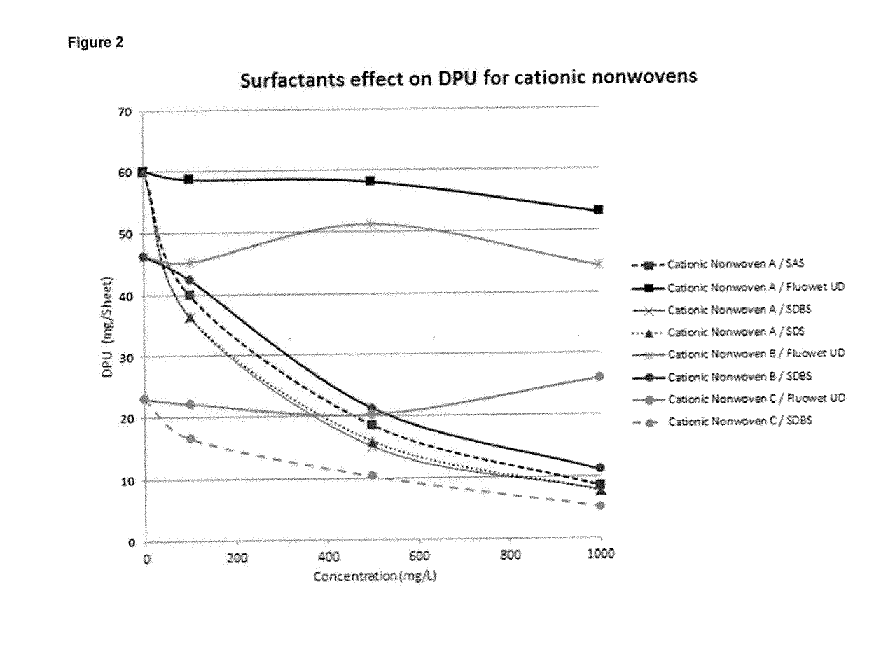

Nonwovens A, B and C were tested for their dye sequestering capacity using the DPU test outlined above under various conditions. DPU tests were conducted using dye solutions with and without surfactants. For DPU tests in the presence of surfactants, four different surfactants were used at three different concentrations. The results are presented in Table 3 and in FIG. 2.

TABLE 3
DPU tests for Cationic Nonwovens A, B and C under various conditions.

| | | DPU for | DPU for | DPU for |
|---|---|---|---|---|
| DPU | | Nonwoven | Nonwoven | Nonwoven |
| test conditions | | A (mg/sheet^{a}) | B (mg/sheet^{b}) | C (mg/sheet^{c}) |
| No surfactant | | 60.1 | 46.3 | 23.0 |
| Fluowet | 0.1 g/L | 58.7 | 45.2 | 22.2 |
| UD | 0.5 g/L | 58.1 | 51.2 | 23.0 |
| | 1.0 g/L | 53 | 44.3 | 26.0 |
| SDBS | 0.1 g/L | 36.4 | 42.5 | 16.6 |
| | 0.5 g/L | 15.1 | 21.2 | 10.3 |
| | 1.0 g/L | 7.9 | 11.0 | 5.1 |
| Hostapur | 0.1 g/L | 39.9 | na | na |
| SAS | 0.5 g/L | 18.5 | na | na |
| | 1.0 g/L | 8.5 | na | na |
| SDS | 0.1 g/L | 36.5 | na | na |
| | 0.5 g/L | 15.9 | na | na |
| | 1.0 g/L | 7.7 | na | na |

Na: data not available,
^{a}sheet size was 25 × 12.5 cm.
^{b}sheet size was 25 × 11.5 cm.
^{c}sheet size was 21.3 × 11.6 cm.

These results show that anionic surfactants have a significant negative impact upon the dye-sequestering performance of Nonwovens A, B and C. Without wishing to be bound by theory, it is believed that these anionic surfactants adsorb onto the cationic laundry aids in competition with dye molecules, which reduces the extent to which the dye molecules are themselves adsorbed.

### Example 3

### Chemical Treatment of Nonwovens A, B and C

Samples of Nonwovens A, B and C were treated with various polymer compositions by padding the sheet with an aqueous solution of the polymer using a Mathis size-press at 1.8 bar of pressure, before being dried on a hot plate at 135° C. for 5 minutes. The amount of these polymers in the resulting samples was adjusted by varying the concentration of the polymers in the padding solution.

The following polymers were used in the polymer compositions: polyvinylalcohols POVAL 28-99, POVAL 15-99, POVAL 20-98, POVAL 10-98, POVAL 4-98 available from Kuraray; polyethylene modified polyvinylalcohol EXCEVAL RS2117 available from Kuraray; potato starch SOLCOAT P55 available from Salami; corn starch IS 035 available from Emsland; cationic starch SOLBOND C-65 available from Solam; and a self-crosslinkable copolymer dispersion of polyvinylacetate-co-polyethylene MOWILITH TE275S available from Celanese. The glyoxal based crosslinker CARTABOND TSI available from Archroma was also added.

A nonwoven Baseweb consisting of a 52 g/m² wetlaid nonwoven comprising 67% cellulose (softwood Sodra Blue 90Z) and 33% viscose (Kelheim Danufil KS 1.7dtx×8 mm) was also prepared and treated with a polymer to produce Baseweb-1 in the same manner as described above. Neither Baseweb nor Baseweb-1 comprises a cationic first substance in accordance with the claims, and therefore indicates the dye-sequestering capability of a representative polymer composition used to treat Nonwovens A, B and C. The various samples produced in this Example are presented in the Table 4.

TABLE 4
Treatment of samples with the ‘second’ polymer.

| | | | Polymer |
|---|---|---|---|
| | | | amount |
| Sample | Base material | Polymer composition | (g/m²) |
| Nonwoven A-1 | Nonwoven A | Solcoat P55 | 10 |
| Nonwoven A-2 | Nonwoven A | Solcoat P55 + Cartabond | 10 |
| | | TSI 90:10 | |
| Nonwoven A-3 | Nonwoven A | IS 035 | 10 |
| Nonwoven A-4 | Nonwoven A | POVAL 4-98 | 10 |
| Nonwoven A-5 | Nonwoven A | POVAL 4-98 + Cartabond | 10 |
| | | TSI 90:10 | |
| Nonwoven A-6 | Nonwoven A | POVAL 10-98 | 10 |
| Nonwoven A-7 | Nonwoven A | POVAL 20-98 | 10 |
| Nonwoven A-8 | Nonwoven A | POVAL 15-99 | 5 |
| Nonwoven A-9 | Nonwoven A | POVAL 15-99 | 10 |
| Nonwoven A-10 | Nonwoven A | POVAL 28-99 | 5 |
| Nonwoven A-11 | Nonwoven A | POVAL 28-99 | 10 |
| Nonwoven A-12 | Nonwoven A | MOWILITH TE275S | 10 |
| Nonwoven A-13 | Nonwoven A | EXCEVAL RS2117 | 5 |
| Nonwoven B-1 | Nonwoven B | POVAL 28-99 | 5 |
| Nonwoven B-2 | Nonwoven B | POVAL 28-99 | 10 |
| Nonwoven C-1 | Nonwoven C | POVAL 28-99 | 10 |
| Baseweb-1 | Baseweb | POVAL 28-99 | 10 |

### Example 4

### Washing Tests

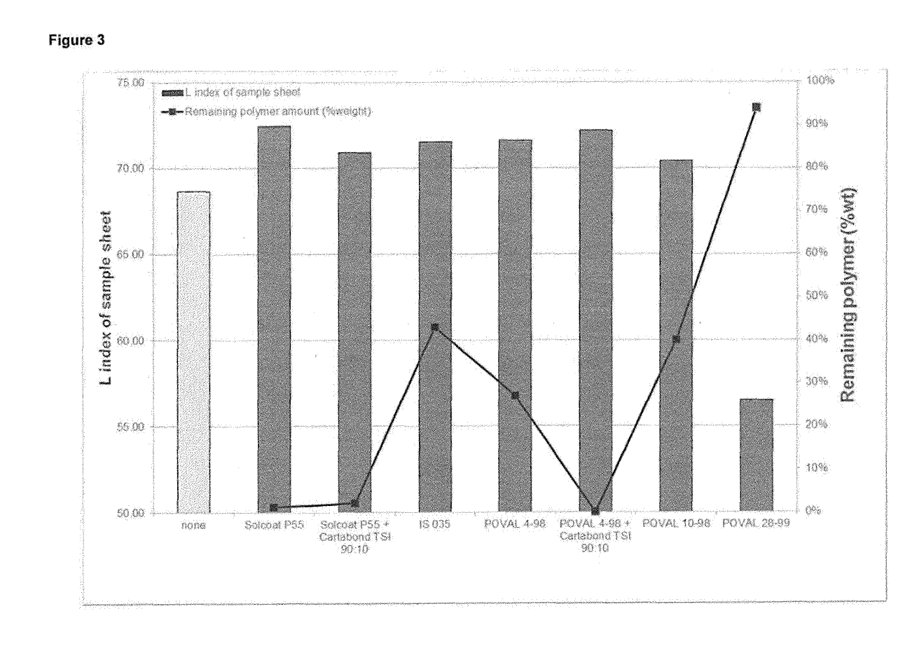

Samples produced in accordance with Example 3 were subjected to the washing machine test procedure outlined above. Each sample underwent a washing cycle at 60° C. in the presence of a fixed amount of detergent and a 5 g cotton swatch colored with a blue dye. At the end of the washing cycle, each sample was dried 2 minutes on a hot plate at 110° C. and tested for its dry weight and its optical Lab values. The results of these tests are presented in Table 4 and in FIG. 3.

L color index measures the color intensity of the sheet after the washing test, which indicates the amount of dye sequestered by the sheet during the washing cycle. The lower the value for the L color index, the higher the amount of dye that have been sequestered onto the laundry aid sheet. The benchmark L color index of 68.67 is provided by Nonwoven A, as this sample did not receive a polymer treatment in accordance with the present invention.

As can be seen from Table 5, the use of POVAL 28-99 resulted in a much lower L color index value, and therefore significantly improved the dye-capturing ability of the laundry aid. It can also be seen that the vast majority of this polymer remained on the sample following the washing machine test. Without wishing to be bound by the theory, it is believed that dye-sequestering performance is improved when more of the polymer treatment remains associated with the laundry aid sample.

TABLE 5
Washing tests.

| | | | Amount of ‘second’ | | | |
|---|---|---|---|---|---|---|
| | | | polymer remaining on | L color | a color | b color |
| Sample | Polymer | Detergent | sample (% weight) | index | index | index |
| Nonwoven A | none | X-tra (20 g) | na | 68.67 | 2.17 | −19.35 |
| Nonwoven A-1 | Solcoat P55 | X-tra (20 g) | 1% | 72.44 | 0.29 | −12.27 |
| Nonwoven A-2 | Solcoat P55 + | X-tra (20 g) | 2% | 70.92 | −1.93 | −7.33 |
| | Cartabond TSI 90:10 | | | | | |
| Nonwoven A-3 | IS 035 | X-tra (20 g) | 43% | 71.54 | −0.07 | −11.78 |
| Nonwoven A-4 | POVAL 4-98 | X-tra (20 g) | 27% | 71.60 | 0.08 | −13.93 |
| Nonwoven A-5 | POVAL 4-98 + | X-tra (20 g) | 0% | 72.20 | −1.04 | −8.56 |
| | Cartabond TSI 90:10 | | | | | |
| Nonwoven A-6 | POVAL 10-98 | X-tra (20 g) | 40% | 70.42 | 0.36 | −15.85 |
| Nonwoven A-11 | POVAL 28-99 | X-tra (20 g) | 85% | 56.47 | 1.55 | −28.09 |

### Example 5

### DPU Tests with Detergent or Surfactant

Samples produced in accordance with Example 3 were examined using the DPU test outlined above in the presence or absence of a detergent or surfactant. The results are presented in Table 6.

TABLE 6
DPU tests with detergent or surfactant

| | | DPU (mg/sheet) | | |
|---|---|---|---|---|
| Laundry | | No | SDBS | Persil |
| aid sample | Polymer treatment | surfactant | 1 g/L | 6 g/L |
| Nonwoven A | none | 60.1 | 7.9 | 24.7 |
| Nonwoven A-10 | POVAL 28-99 (5 g/m²) | 61.7 | 8.8 | 41.4 |
| Nonwoven A-11 | POVAL 28-99 (10 g/m²) | 56.2 | 12 | 29.4 |
| Nonwoven B | none | 46.3 | 1 | 23.8 |
| Nonwoven B-1 | POVAL 28-99 (5 g/m²) | 43.4 | na | 25 |
| Nonwoven B-2 | POVAL 28-99 (10 g/m²) | 35.5 | na | 35 |
| Baseweb | none | 4 | na | na |
| Baseweb-1 | POVAL 28-99 (10 g/m²) | 2.5 | na | na |

The samples treated with POVAL 28-99 were far better at capturing dye molecules than samples not benefitting from this polymer treatment. This was particularly evident in tests in which a detergent or surfactant was also present. The results obtained with Baseweb and Baseweb-1 show that the second polymer itself does not capture dye molecules itself. The results as a whole instead show that the polyvinyl alcohol coating counterintuitively improves the dye-capturing performance of the cationic first substance.

### Example 6

### DPU Tests Following Pre-washing with Surfactant

Samples produced in accordance with Example 3 were washed with an anionic surfactant for 10 minutes in the manner described above. Samples were then removed from the surfactant solution and dried, prior to being tested using the DPU test described above. The DPU measurements were performed in dye solution without any surfactant present, apart from residual surfactant present on each sample following the pre-washing step. The results of this test are presented in Table 7.

TABLE 7
DPU tests following pre-washing with surfactant.

| | | DPU after |
|---|---|---|
| | | pre-washing in 1 g/L |
| Laundry Aid Sample | Polymer | SDBS (mg/sheet) |
| Nonwoven A | none | 11.6 |
| Nonwoven A-10 | POVAL 28-99 (5 g/m²) | 24 |
| Nonwoven A-11 | POVAL 28-99 (10 g/m²) | 23 |
| Nonwoven B | none | 25.8 |
| Nonwoven B-1 | POVAL 28-99 (5 g/m²) | 38.6 |
| Nonwoven B-2 | POVAL 28-99 (10 g/m²) | 34.4 |

These results show that the samples were able to capture significant amounts of dye despite having been previously exposed to an anionic surfactant, which indicates that the anionic surfactant is able to desorb from the sample. The superior results obtained for samples treated with POVAL 28-99 indicate that this treatment reduces the relative ability of the surfactant to bind to the sample when compared with the ability of the dye to bind to the sample.

### Example 7

### DPU Tests Following Pre-washing with Detergent

Samples produced in accordance with Example 3 were subjected to a test designed to replicate the conditions encountered during washing cycle. In a regular washing cycle, the laundry garments and laundry aid contact the wash water and the detergent at a lower temperature because the wash water is yet to be heated. The washing composition is then heated in the washing machine until the desired temperature is achieved, which is estimated to occur over a period of 10 minutes. Dyes are released at elevated temperatures, meaning that the laundry aid is not in contact with the released free dye in the first minutes of the wash cycle. This also means that when the free dyes are released in the washing liquor, the laundry has already been in contact with the detergent components (surfactants for instance) for about 10 minutes. The free dyes are then present in the washing liquor as well as the detergent components until the evacuation of the washing liquor followed by rinsing steps in the wash cycle.

Accordingly, the samples in this test were pre-washed for 10 minutes with a 6 g/L Persil detergent composition at a temperature of 20 ° C. Samples were then dried and tested using the DPU test outlined above and in presence of Persil detergent at a concentration of 6 g/L. The results are presented in Table 8.

TABLE 8
DPU tests with pre-washing with detergent

| | | | DPU after |
|---|---|---|---|
| | | | pre-washing |
| Laundry Aid | | DPU | Persil 6 g/L |
| Sample | Polymer | (mg/L)* | (mg/L)** |
| Nonwoven A | none | 60.1 | 7.8 |
| Nonwoven A-1 | Solcoat P55 (10 g/m²) | 23.7 | 10 |
| Nonwoven A-4 | POVAL 4-98 (10 g/m²) | na | 11 |
| Nonwoven A-6 | POVAL 10-98 (10 g/m²) | na | 15.8 |
| Nonwoven A-7 | POVAL 20-98 (10 g/m²) | na | 17.9 |
| Nonwoven A-8 | POVAL 15-99 (5 g/m²) | 58 | 10 |
| Nonwoven A-9 | POVAL 15-99 (10 g/m²) | 55.9 | 18.6 |
| Nonwoven A-10 | POVAL 28-99 (5 g/m²) | 63.6 | 17.4 |
| Nonwoven A-11 | POVAL 28-99 (10 g/m²) | 55.5 | 17.8 |
| Nonwoven A-12 | MOWILITH TE275S | 9.1 | 6.9 |
| | (10 g/m²) | | |
| Nonwoven A-13 | EXCEVAL RS2117 (5 g/m²) | 36.9 | 16.3 |
| Nonwoven B | none | 46.3 | 14.4 |
| Nonwoven B-1 | POVAL 28-99 (5 g/m²) | 43.4 | 16.9 |
| Nonwoven B-2 | POVAL 28-99 (10 g/m²) | 35.5 | 24.4 |
| Nonwoven C | none | 23 | 3.8 |
| Nonwoven C-1 | POVAL 28-99 (10 g/m²) | 15.5 | 16.7 |

*DPU measured without surfactant or detergent
**DPU measured in presence of Persil detergent at a concentration of 6 g/L

As shown in Table 8, samples benefitting from the polymer treatment were able to capture significantly more dye in the presence of detergent components than samples not benefitting from the polymer treatment. These results also show that polyvinylalcohols are particularly useful polymers, and particularly those with high molecular weight and a high degree of hydrolysis.

### Example 8

### Comparative Washing Tests

Samples produced in accordance with Example 3 were tested using the washing machine test outlined above, except that all the samples were in the washing drum together. Samples were tested in presence of a 20 g of detergent X-tra and 21 g of the dyed cotton fabric swatch at 60° or 40° as indicated, before being dried for 2 minutes on a hot plate at 110° C. The mass and optical Lab values of the dried samples were then then recorded. The results are reported in Tables 9 and 10.

TABLE 9
Washing tests at 60° C.

| | | Remaining | |
|---|---|---|---|
| | | polymer | L color |
| Laundry | | amount | index |
| Aid Sample | Polymer | (% weight) | (%) |
| Nonwoven A | none | na | 63.40 |
| Nonwoven A-8 | POVAL 15-99 (5 g/m²) | 100.00 | 59.6 |
| Nonwoven A-9 | POVAL 15-99 (10 g/m²) | 71.00 | 58.3 |
| Nonwoven A-10 | POVAL 28-99 (5 g/m²) | 100.00 | 59.4 |
| Nonwoven A-11 | POVAL 28-99 (10 g/m²) | 88.00 | 58.9 |
| Nonwoven A-13 | EXCEVAL RS2117 (5 g/m²) | 100.00 | 61 |

TABLE 10
Washing tests at 40° C.

| | | Remaining | |
|---|---|---|---|
| | | polymer | |
| | | amount | L color |
| Laundry aid sample | Polymer | (% weight) | index (%) |
| Nonwoven A | none | na | 73.5 |
| Nonwoven A-8 | POVAL 15-99 (5 g/m²) | 100.00 | 69.4 |
| Nonwoven A-9 | POVAL 15-99 (10 g/m²) | 87.00 | 69.2 |
| Nonwoven A-10 | POVAL 28-99 (5 g/m²) | 100.00 | 69 |
| Nonwoven A-11 | POVAL 28-99 (10 g/m²) | 88.00 | 69 |
| Nonwoven A-13 | EXCEVAL RS2117 | 79.00 | 72.6 |
| | (5 g/m²) | | |

The results reported in Tables 9 and 10 show that samples benefitting from the polymer treatment were able to capture more dye in washing machine cycle.

### Example 9

### Physical Properties

Physical properties for samples produced in accordance with Example 3 are reported below in Table 11. These results show that the polymer treatment also significantly improves several important physical properties when compared with an untreated sample.

TABLE 11
Physical properties

| | Laundry Aid Sample | | | | | | |
|---|---|---|---|---|---|---|---|
| | Nonwoven | Nonwoven | Nonwoven | Nonwoven | Nonwoven | Nonwoven | Nonwoven |
| | B | A | A-10 | A-11 | A-8 | A-9 | A-13 |
| Polymer | none | none | Poval 28-99 | Poval 28-99 | Poval 15-99 | Poval 15-99 | RS2117 |
| Polymer amount (g/m²) | none | none | 5 | 10 | 5 | 10 | 5 |
| Basis weight (g/m²) | 63.2 | 59.1 | 67.2 | 70 | 67.6 | 69.6 | 67.2 |
| Thickness (μm) | 169 | 242 | 238 | 246 | 248 | 233 | 235 |
| Dry tensile strength (N/m) | 2263 | 1922 | 2710 | 2836 | 2726 | 2789 | 2789 |
| Wet tensile strength (N/m) | 527 | 604 | 848 | 1099 | 969 | 1055 | 1011 |
| Wet/dry tensile ratio (%) | 23.3 | 31.4 | 31.3 | 38.8 | 35.6 | 37.8 | 36.2 |
| Whiteness (%) | 82 | 81.4 | 78.0 | 78.9 | 80.2 | 78.9 | 80.3 |
| Trapezoidal tear (cN) | 219 | 228 | 207 | 168 | 176 | 181 | 203 |
| Handle-o-meter rigidity (g) | 103 | 170 | 218 | 303 | 284 | 279 | 269 |
| Bending Stiffness (cN) | 80 | 117 | 147 | 158 | 152 | 142 | 162 |

As will be understood from the preceding description of the present invention and the illustrative experimental examples, the present invention can also be described by reference to the following embodiments:

1. A dye-capturing laundry aid comprising:
a support in the form of a sheet comprising water-insoluble fibers;
a first substance anchored to the support, wherein the first substance has moieties that are cationic when exposed to water at one or more pH values in the pH range of from 6 to 10; and
a second substance that coats the first substance, wherein the second substance is a polymer that remains substantially coated upon the first substance when the laundry aid is exposed to water over the pH range of from 6 to 10, and at least 50% of the repeating units in the polymer have a structure according to the following Formula (1):

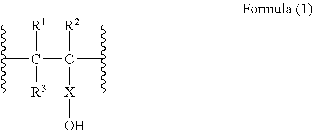

wherein R¹, R² and R³ each independently represents H, a C₁₋₃ alkyl group, a C₂₋₃ alkenyl group, a C₃₋₆ cycloalkyl group, a C₆₋₁₀ aryl group or a C₃₋₆ heterocyclic group, and each of which being optionally substituted with a hydroxyl group; and
X represents a covalent bond, a C₁₋₃ alkylene group, a C₃₋₆ cycloalkylene group, a C₆₋₁₀ arylene group or a C₃₋₆ heterocyclic group.

2. A dye-capturing laundry aid according to embodiment 1, wherein the first substance is a first polymer.

3. A dye-capturing laundry aid according to embodiment 1, wherein the first substance comprises non-polymeric molecules that are covalently bonded to water-insoluble fibers of the support.

4. A dye-capturing laundry aid according to any preceding embodiment, wherein the first substance has moieties that are cationic when exposed to water at pH 10.

5. A dye-capturing laundry aid according to any preceding embodiment, wherein:
R¹, R² and R³ each independently represents H or a C₁₋₃ alkyl group optionally substituted with a hydroxyl group; and

X represents a covalent bond or a C₁₋₃ alkylene group.

6. A dye-capturing laundry aid according to any preceding embodiment, wherein the repeating unit comprising the structure according to Formula (1) is a repeating unit according to Formula (2):

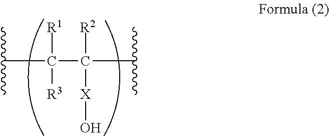

wherein R¹, R², R³ and X are as defined above.

7. A dye-capturing laundry aid according to any preceding embodiment, wherein the repeating unit comprising the structure according to Formula (1) or the repeating unit according to Formula (2) is a repeating unit according to Formula (3):

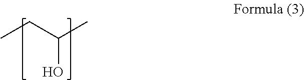

8. A dye-capturing laundry aid according to any preceding embodiment, wherein at least 90% of the repeating units in the second polymer are repeating units according to Formula (3).

9. A dye-capturing laundry aid according to any preceding embodiment, wherein the second polymer is a polyvinyl alcohol having a viscosity of at least 5 mPa·s when measured as a 4% w/w aqueous solution at 20° C. and in accordance with DIN 53015.

10. A dye-capturing laundry aid according to any of embodiments 1, 2 and 4-9, wherein:
the first substance is a first polymer that is a water-soluble polyamine comprising primary amine groups and is anchored to the support as part of a three-dimensional network entangled with at least some of the fibers contained in the support; and
the three-dimensional network comprises the first polymer cross-linked by a third polymer, the third polymer being a water soluble polymer that is different from the first polymer and comprises repeating units comprising halohydrin and/or epoxide groups that are capable of forming covalent cross-links with the primary amine groups of the first polymer.

11. A dye-capturing laundry aid according to embodiment 10, wherein titration of a pH 6.5 aqueous composition that has been obtained by immersing 50 g of the laundry aid in one liter of water at 70° C. for 10 minutes requires ≦3 mmol of NaOH to raise the pH of the aqueous composition from 6.5 to 10.5 at 25° C.

12. The dye-capturing laundry aid according to embodiment 10 or 11, wherein the halohydrin groups of the third polymer are chiorohydrin groups according to the following Formula (A):

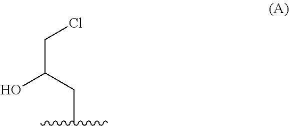 [SMILES: *CC(O)CCl]

13. The dye-capturing laundry aid according to any of embodiments 10 to 12, wherein the third polymer contains quaternary ammonium groups in the polymer.

14. The dye-capturing laundry aid according to any of embodiments 10 to 13, wherein the third polymer is a diallyl(3-chloro-2-hydroxypropyl)amine hydrochloride-diallyldimethylammonium chloride copolymer having the repeating units illustrated in following Formula (B):

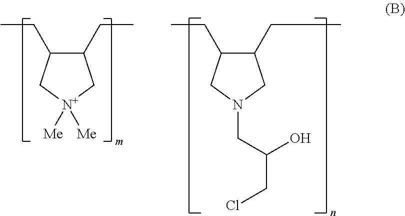

wherein the ratio of m:n in the polymer is in the range of from 1:9 to 9:1.

15. The dye-capturing laundry aid according to any of embodiments 10 to 14, wherein the average molecular weight of the third polymer in isolation is at least 1,000, preferably higher than 20,000.

16. The dye-capturing laundry aid according any of preceding embodiment, wherein the first substance is a first polymer and is at least one of poly(allyl amine), poly(ethylene imine), partially hydrolyzed poly(vinylformamide), polyvinylamide, chitosan and copolymers of the mentioned polyamines with any type of monomers.

17. The dye-capturing laundry aid according to any preceding embodiment, wherein the first substance is a first polymer and the average molecular weight of the first polymer in isolation is at least 20,000, preferably higher than 100,000.

18. The dye-capturing laundry aid according to any preceding embodiment, wherein the first substance is a first polymer that in isolation comprises side-chains having quaternary ammonium groups.

19. The dye-capturing laundry aid according to embodiment 18, wherein the first polymer has side chains formed by reacting the first polymer with glicidyl trimethylammonium chloride and/or 3-chloro-2-hydroxypropyl trimethylammonium chloride as grafting reactants.

20. The dye-capturing laundry aid according to any preceding embodiment, wherein the fibers in the support comprise at least one of cellulose, viscose, lyocell, a polyalkene, a polyester, a poly(alkylene terephthalate) and copolymers thereof.

21. The dye-capturing laundry aid according to any preceding embodiment, wherein the fibers in the support comprise polyethylene, polypropylene, polyethylene terephthalate, polylactic acid, or a mixture or a copolymer thereof, preferably wherein the fibers in the support consist of polyethylene, polypropylene, polyethylene terephthalate, polylactic acid, or a mixture or a copolymer thereof.

22. The dye-capturing laundry aid according to any of embodiments 10-21, wherein:
the first polymer is a polyvinylamine-based polymer having an average molecular weight in the range of 100,000 and 750,000;
the third polymer is an epichlorohydrin-modified polyimide having an average molecular weight in the range of from 5,000 to 100,000;
the mass ratio of the first and third polymers is in the range of ro 97:3 to 75:25; and
optionally wherein the ratio of chlorohydrin groups to the N—H groups between the third and first polymers is in the range of from 0.0035 to 0.0380.

23. The dye-capturing laundry aid according to any of embodiments 10-21, wherein:
the first polymer is a polyethyleneimine having an average molecular weight in the range of 100,000 and 1,000,000;
the third polymer is a polymer having both quaternary ammonium groups and epichlorohydrin groups and has an average molecular weight in the range of from 5,000 to 200,000;
the mass ratio of the first and third polymers is in the range of from 97:3 to 50:50; and
optionally wherein the ratio of chlorohydrin groups to the N—H groups between the third and first polymers is in the range of from 0.0035 to 1.0000.

24. The dye-capturing laundry aid according to any of embodiments 10-21, wherein:
the first polymer is a polyallylamine comprising quaternary ammonium groups and has an average molecular weight in the range of 100,000 and 1,000,000;
the third polymer is a polymer having both quaternary ammonium groups and epichlorohydrin groups and has an average molecular weight in the range of from 5,000 to 200,000;
the mass ratio of the first and third polymers is in the range of from 97:3 to 75:25; and
optionally wherein the ratio of chlorohydrin groups to the N—H groups between the third and first polymers is in the range of from 0.0035 to 0.0380.

25. The dye-capturing laundry aid according to any preceding embodiment, wherein the fibrous support comprises a heat-sealable component in at least a portion of the support.

26. The dye-capturing laundry aid laundry aid according to any preceding embodiment, wherein the laundry aid forms a porous envelope surrounding an inner chamber.

27. A process of producing a dye-capturing laundry aid as defined in any preceding embodiment, comprising:
(i) anchoring the first substance to the support; and
(ii) coating the first substance with the second polymer.

28. A process of producing a dye-capturing laundry aid as defined in any of embodiments 10-26, comprising:
(i) anchoring the first polymer to the support; and
(ii) coating the first polymer with the second polymer;
wherein step (i) is implemented by sequentially or simultaneously impregnating the fiber-containing support with the first polymer and the third polymer, and cross-linking the first polymer with the third polymer to form the three-dimensional network of cross-linked first and third polymers.

29. The dye-capturing laundry aid according to any one of embodiments 1-9, wherein the laundry aid is obtainable by a process as defined in embodiment 27.

30. The dye-capturing laundry aid according to any one of embodiments 10-26, wherein the laundry aid is obtainable by a process as defined in embodiment 28.

31. Use of a dye-capturing laundry aid as defined in any one of embodiments 1-26, 29 and 30 to scavenge a dye or dyes from an aqueous medium.

1-15. (canceled)

16. A dye-capturing laundry aid comprising:
a support in the form of a sheet comprising water-insoluble fibers;
a first substance anchored to the support, wherein the first substance has moieties that are cationic when exposed to water at one or more pH values in the pH range of from 6 to 10; and
a second substance that coats the first substance, wherein the second substance is a polymer that remains substantially coated upon the first substance when the laundry aid is exposed to water over the pH range of from 6 to 10, and at least 50% of the repeating units in the polymer have a structure according to the following formula (1): 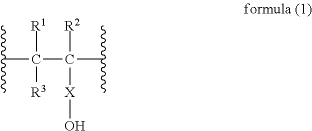
wherein R¹, R² and R³ each independently represents H or a C₁₋₃ alkyl group, a C₂₋₃ alkenyl group, a C₃₋₆ cycloalkyl group, a C₆₋₁₀ aryl group or a C₃₋₆ heterocyclic group, and each of which being optionally substituted with a hydroxyl group; and
X represents a covalent bond, a C₁₋₃ alkylene group, a C₃₋₆ cycloalkylene group, a C₆₋₁₀ arylene group or a C₃₋₆ heterocyclic group.

17. A dye-capturing laundry aid according to claim 16, wherein the first substance is a first polymer.

18. A dye-capturing laundry aid according to claim 16, wherein the first substance comprises non-polymeric molecules that are covalently bonded to water-insoluble fibers of the support.

19. A dye-capturing laundry aid according to claim 16, wherein:
R¹, R² and R³ each independently represents H or a C₁₋₃ alkyl group optionally substituted with a hydroxyl group; and
X represents a covalent bond or a C₁₋₃ alkylene group.

20. A dye-capturing laundry aid according to claim 16, wherein the repeating unit comprising the structure according to formula (1) is a repeating unit according to formula (2): 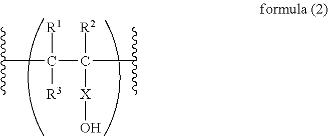
wherein R¹, R², R³ and X are as defined above.

21. A dye-capturing laundry aid according to claim 16, wherein the repeating unit comprising the structure according to formula (1) is a repeating unit according to formula (3):

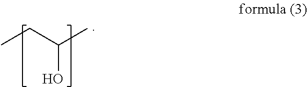

22. A dye-capturing laundry aid according to claim 20, wherein the repeating unit comprising the structure according to formula (1) or the repeating unit according to formula (2) is a repeating unit according to formula (3):

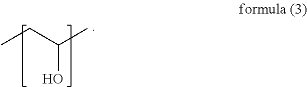

23. A dye-capturing laundry aid according to claim 21, wherein at least 90% of the repeating units in the second substance are repeating units according to formula (3).

24. A dye-capturing laundry aid according to claim 22, wherein at least 90% of the repeating units in the second substance are repeating units according to formula (3).

25. A dye-capturing laundry aid according to claim 16, wherein the second substance is a polyvinyl alcohol having a viscosity of at least 5 mPa·s when measured as a 4% w/w aqueous solution at 20° C. and in accordance with DIN 53015.

26. A dye-capturing laundry aid according to claim 16, wherein:
the first substance is a first polymer that is a water-soluble polyamine comprising primary amine groups and is anchored to the support as part of a three-dimensional network entangled with at least some of the fibers contained in the support; and
the three-dimensional network comprises the first polymer cross-linked by a third polymer, the third polymer being a water soluble polymer that is different from the first polymer and comprises repeating units comprising halohydrin and/or epoxide groups that are capable of forming covalent cross-links with the primary amine groups of the first polymer.

27. A dye-capturing laundry aid according to claim 19, wherein:
the first substance is a first polymer that is a water-soluble polyamine comprising primary amine groups and is anchored to the support as part of a three-dimensional network entangled with at least some of the fibers contained in the support; and
the three-dimensional network comprises the first polymer cross-linked by a third polymer, the third polymer being a water soluble polymer that is different from the first polymer and comprises repeating units comprising halohydrin and/or epoxide groups that are capable of forming covalent cross-links with the primary amine groups of the first polymer.

28. A dye-capturing laundry aid according to claim 26, wherein the third polymer contains quaternary ammonium groups.

29. A dye-capturing laundry aid according to claim 27, wherein the third polymer contains quaternary ammonium groups.

30. A dye-capturing laundry aid according to claim 16, wherein the first substance is a first polymer and the first polymer in isolation comprises side-chains having quaternary ammonium groups.

31. A dye-capturing laundry aid according to claim 19, wherein the first substance is a first polymer and the first polymer in isolation comprises side-chains having quaternary ammonium groups.

32. The dye-capturing laundry aid according to claim 16, wherein the fibers in the support comprise at least one of cellulose, viscose, lyocell, a polyalkene, a polyester, a poly(alkylene terephthalate) and copolymers thereof.

33. A process of producing a dye-capturing laundry aid as defined in claim 16, comprising:
(i) anchoring the first substance to the support; and
(ii) coating the first substance with the second substance.

34. The dye-capturing laundry aid according to claim 16, wherein the laundry aid is obtainable by a process as defined in claim 33.

35. Use of a dye-capturing laundry aid as defined in claim 16 to scavenge a dye or dyes from an aqueous medium.
